(19) United States
(12) Patent Application Publication
(10) Pub. No.: US 2026/0044182 A1
(43) Pub. Date: Feb. 12, 2026

(54) DISPLAY DEVICE

(71) Applicant: LG ELECTRONICS INC., Seoul (KR)

(72) Inventor: Hyunseung YOUN, Seoul (KR)

(73) Assignee: LG ELECTRONICS INC., Seoul (KR)

(21) Appl. No.: 19/291,392

(22) Filed: Aug. 5, 2025

(30) Foreign Application Priority Data
Aug. 8, 2024 (WO) PCT/KR2024/011780

(51) Int. Cl. G06F 1/16; H04R 1/02

(52) U.S. Cl. CPC G06F 1/1605; H04R 1/025; H04R 1/026; H04R 2499/15

(57) ABSTRACT

A display device is disclosed. The display device may include: a display panel; a frame disposed at a rear of the display panel; a speaker coupled to a rear of the frame; and a cable disposed at the rear of the frame, wherein: the speaker may include: a speaker box; a first wiring set protruding from one side of the speaker box and disposed along the one side; and a second wiring set protruding from the one side of the speaker box, disposed along the one side, and spaced apart from the first wiring set in a thickness direction of the speaker box, and the cable may be engaged with any one of the first wiring set and the second wiring set that is positioned farther from a rear surface of the frame.

### CROSS-REFERENCE TO RELATED APPLICATIONS

Pursuant to 35 U.S. C. § 119, this application claims the benefit of earlier filing date and right of priority to International Application No. PCT/KR2024/011780, filed on Aug. 8, 2024, the contents of which are all hereby incorporated by reference herein in their entireties.

### BACKGROUND OF THE INVENTION

### Field of the Invention

The present disclosure relates to a display device.

### Description of the Related Art

With the development of information society, there has been a growing demand for various types of display devices. In order to meet such demand, various display devices, such as a liquid crystal display (LCD) device, a plasma display panel (PDP), an electro luminescent display (ELD), a vacuum fluorescent display (VFD), an organic light emitting diode (OLED) display device, and the like, have been developed and used.

Among them, an LCD panel includes a TFT substrate and a color substrate that are opposite each other with a liquid crystal layer interposed therebetween, and can display an image using light provided from a backlight unit. In addition, an OLED panel can display an image by depositing a self-luminescent organic layer on a substrate having a transparent electrode formed thereon.

Such a display device includes a speaker. Here, a speaker is a device that converts electrical audio signals into sound waves. The speaker can be subdivided into a woofer, a mid-range, and a tweeter depending on the frequency range.

Due to the recent trend of slimmer display devices, the thickness of a speaker provided in a display device is also becoming thinner.

### SUMMARY OF THE INVENTION

It is an object of the present disclosure to solve the above and other problems.

Another object of the present disclosure may be to provide a structure for wiring a cable to a speaker.

Another object of the present disclosure may be to provide a structure for coupling a speaker to a frame and a structure for coupling a cable to the speaker.

Another object of the present disclosure may be to provide a structure in which a first speaker and a second speaker, which is an inverted version of the first speaker, are coupled to a frame.

Another object of the present disclosure may be to provide a structure for wiring a cable to a first speaker and/or a second speaker.

Another object of the present disclosure may be to provide a structure that can extend a bass reproduction range by increasing the volume of a speaker.

Another object of the present disclosure may be to provide a speaker that is compatible with various types of display devices.

In accordance with an aspect of the present disclosure for achieving the above and other objects, a display device may include: a display panel; a frame positioned behind the display panel; a speaker coupled to a rear of the frame; and a cable disposed at the rear of the frame, wherein the speaker may include: a speaker box; a first wiring set protruding from one side of the speaker box and disposed along the one side; and a second wiring set protruding from the one side of the speaker box, disposed along the one side, and spaced apart from the first wiring set in a thickness direction of the speaker box, and wherein the cable may be engaged with any one of the first wiring set and the second wiring set that is positioned farther from a rear surface of the frame.

A sound device may include: a frame; a speaker coupled to a rear of the frame; and a cable disposed at the rear of the frame, wherein the speaker may include: a speaker box; a first wiring set protruding from one side of the speaker box and disposed along the one side; and a second wiring set protruding from the one side of the speaker box, disposed along the one side, and spaced apart from the first wiring set in a thickness direction of the speaker box, and wherein the cable may be engaged with any one of the first wiring set and the second wiring set that is positioned farther from a rear surface of the frame.

### BRIEF DESCRIPTION OF THE DRAWINGS

The above and other objects, features and advantages of the present invention will be more apparent from the following detailed description in conjunction with the accompanying drawings, in which:

FIGS. 1 to 28 are diagrams illustrating examples of a display device according to embodiments of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand various technical features and it should be understood that the embodiments disclosed herein are not limited by the accompanying drawings. As such, the present disclosure should be construed to extend to any alterations, equivalents, and substitutes in addition to those which are particularly set out in the accompanying drawings.

Although the terms “first”, “second”, etc. may be used herein to describe various elements, these elements should not be limited by these terms. These terms are only used to distinguish one element from another.

It will be understood that when a component is referred to as being “coupled” or “connected” to another component, it may be directly coupled or connected to another component, or intervening components may be present. In contrast, when a component is referred to as being “directly coupled” or “directly connected” to another component, there are no intervening components present.

A singular representation may include a plural representation unless the context clearly indicates otherwise.

Terms such as “comprises or includes” or “has” are used herein and should be understood that they are intended to indicate an existence of features, numbers, steps, operations, elements, components, or combinations thereof, disclosed in the specification, but do not preclude the presence or addition of one or more other features, numbers, steps, operations, elements, components, or combinations thereof.

The directions “up (U)”, “down (D)”, “left (Le)”, “right (Ri)”, “front (F)”, and “rear (R)” shown in the drawings are used only for convenience of description, and the technical concept disclosed in this specification is not limited by these directions.

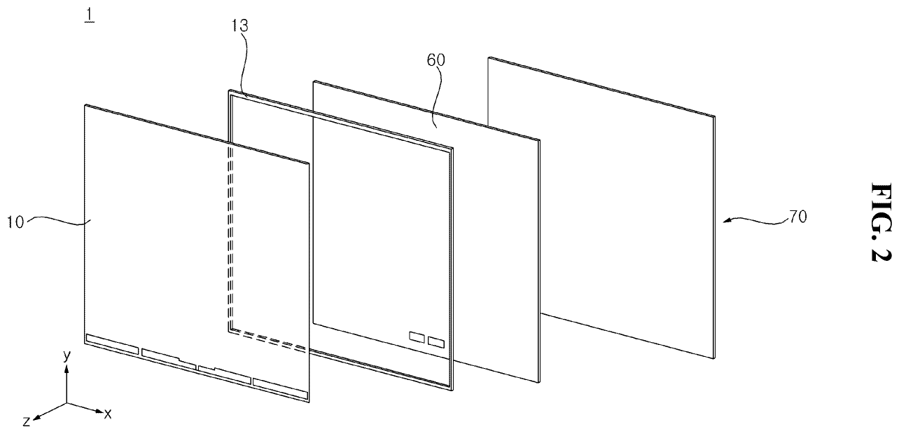

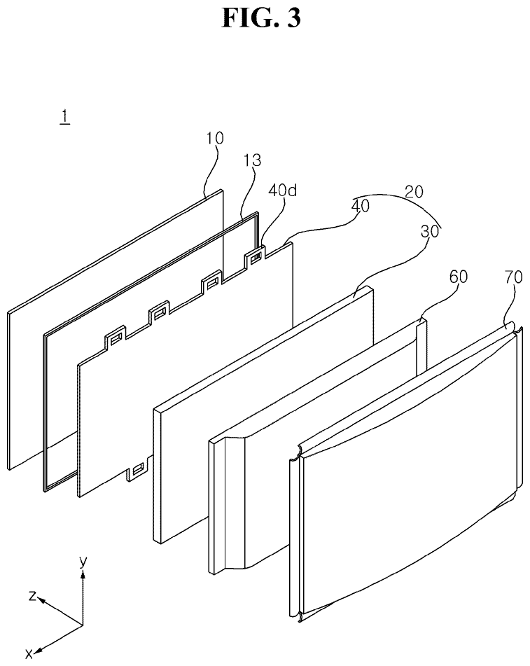

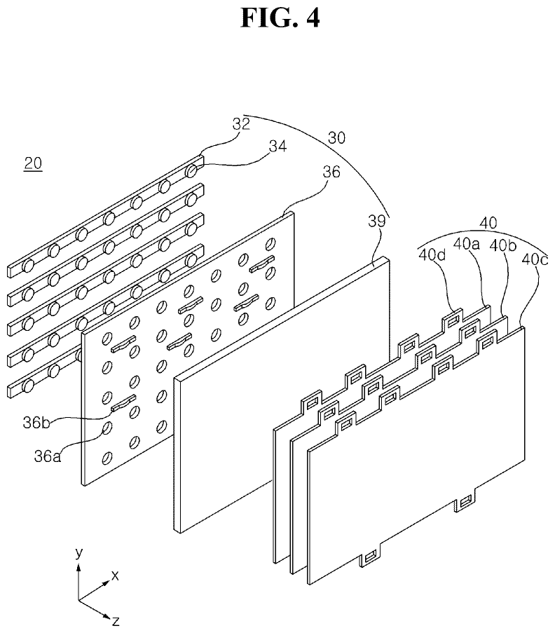

In the following description, the display panel of the present disclosure may be an OLED panel, which will be described later with reference to FIG. 2, or an LCD panel, which will be described later with reference to FIGS. 3 and 4, but the present disclosure may also be applied to various other types of display panels.

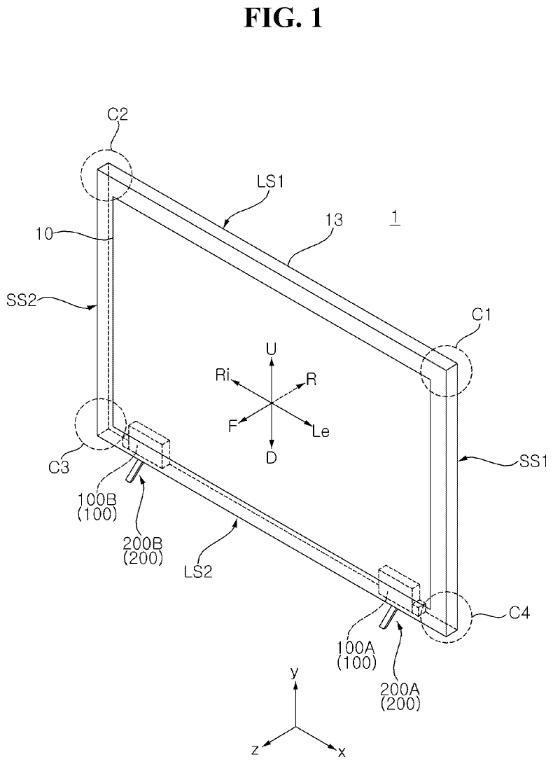

Referring to FIG. 1, a display device 1 may include a display panel 10. The display panel 10 may display an image.

The display device 1 may include a first long side LS1, a second long side LS2 opposite the first long side LS1, a first short side SS1 adjacent to the first long side LS1 and the second long side LS2, and a second short side SS2 opposite the first short side SS1. Meanwhile, for ease of explanation, it is illustrated and described that lengths of the first and second long sides LS1 and LS2 are greater than lengths of the first and second short sides SS1 and SS2, but the lengths of the first and second long sides LS1 and LS2 may be substantially equal to the lengths of the first and second short sides SS1 and SS2.

A direction parallel to the long sides LS1 and LS2 of the display device 1 may be referred to as a left-right direction. A direction parallel to the short sides SS1 and SS2 of the display device 1 may be referred to as an up-down direction. A direction perpendicular to the long sides LS1 and LS2 and the short sides SS1 and SS2 of the display device 1 may be referred to as a front-rear direction.

A direction in which the display panel 10 displays an image may be referred to as a front (F, z), and a direction opposite to the front may be referred to as a rear (R). The first long side LS1 may be referred to as an upper side (U, y), and the second long side LS2 may be referred to as a lower side (D). The first short side SS1 may be referred to as a left side (Le, x), and the second short side SS2 may be referred to as a right side (Ri).

The first long side LS1, the second long side LS2, the first short side SS1, and the second short side SS2 may be referred to as edges of the display device 1. A side frame 13 (see FIGS. 2 and 3), which will be described later, may define the edges of the display device 1. Points where the first long side LS1, the second long side LS2, the first short side SS1, and the second short side SS2 meet one another may be referred to as corners. A point where the first short side SS1 and the first long side LS1 meet may be referred to as a first corner C1. A point where the first long side LS1 and the second short side SS2 meet may be referred to as a second corner C2. A point where the second short side SS2 and the second long side LS2 meet may be referred to as a third corner C3. A point where the second long side LS2 and the first short side SS1 meet may be referred to as a fourth corner C4.

Referring to FIG. 2, the display device 1 may include a display panel 10, a side frame 13, a frame 60, and a back cover 70.

The display panel 10 may define a front surface of the display device 1, and may display an image. The display panel 10 may include a plurality of pixels to output an image in accordance with color, brightness, and chroma of each pixel. The display panel 10 may be divided into an active area in which an image is displayed and a de-active area in which no image is displayed. The display panel 10 may generate light corresponding to red, green or blue color in response to a control signal. The display panel 10 may be referred to as an OLED panel.

The side frame 13 may extend along the periphery of the display panel 10. The side frame 13 may be referred to as a guide panel 13 or a middle cabinet 13.

The frame 60 may be positioned at the rear of the display panel 10, and may be coupled to the display panel 10. The side frame 13 may be positioned between the display panel 10 and the frame 60, and may be coupled to the display panel 10 and the frame 60. Electronic components may be mounted on the frame 60. For example, the frame 60 may include a metal material such as an aluminum alloy or the like. The frame 60 may be referred to as a main frame 60, a module cover 60, or a bottom cover 60.

The back cover 70 may cover the rear of the frame 60. The back cover 70 may be coupled to the frame 60. For example, the back cover 70 may be an injection-molded part made of resin. As another example, the back cover 70 may include a metal material.

Referring to FIG. 3, the display device 1 may include a display panel 10, a side frame 13, a backlight unit 20, a frame 60, and a back cover 70.

The display panel 10 may define a front surface of the display device 1, and may display an image. The display panel 10 may display an image in such a manner that each of a plurality of pixels outputs red, green or blue (RGB) light in accordance with timing. The display panel 10 may be divided into an active area in which an image is displayed and a de-active area in which no image is displayed. The display panel 10 may include a front substrate and a rear substrate that are opposite each other with a liquid crystal layer interposed therebetween. The display panel 10 may be referred to as an LCD panel.

The front substrate may include a plurality of pixels, each of which consists of red, green, and blue sub-pixels. The front substate may output light corresponding to red, green or blue color in response to a control signal.

The rear substrate may include switching elements. The rear substrate may switch a pixel electrode. For example, the pixel electrode may change the molecular arrangement of a liquid crystal layer in response to a control signal input from the outside. The liquid crystal layer may include liquid crystal molecules. The arrangement of the liquid crystal molecules may be changed according to a voltage difference between the pixel electrode and a common electrode. The liquid crystal layer may transmit light provided from the backlight unit 20 to the front substrate or block the light.

The side frame 13 may extend along the periphery of the display panel 10. The side frame 13 may be referred to as a middle cabinet 13 or a side frame 13.

The backlight unit 20 may be positioned at the rear of the display panel 10. The backlight unit 20 may include light sources. The backlight unit 20 may be coupled to a front surface of the frame 60. The backlight unit 20 may be driven by a full driving scheme or a partial driving scheme such as local dimming or impulsive driving. The backlight unit 20 may include an optical sheet 40 and an optical layer 30.

The optical sheet 40 may allow light from the light source to be uniformly transmitted to the display panel 10. The optical sheet 40 may consist of a plurality of layers. For example, the optical sheet 40 may include a prism sheet, a diffusion sheet, etc.

The frame 60 may be positioned behind the display panel 10, and the display panel 10 may be coupled thereto. The side frame 13 may be positioned between the display panel 10 and the frame 60, and may be coupled to the display panel 10 and the frame 60. Electronic components may be mounted on the frame 60. For example, the frame 60 may include a metal material such as an aluminum alloy or the like. The frame 60 may be referred to as a main frame 60, a module cover 60, or a bottom cover 60.

The back cover 70 may cover the rear of the frame 60. The back cover 70 may be coupled to the frame 60. For example, the back cover 70 may be an injection-molded part made of resin. As another example, the back cover 70 may include a metal material.

Referring to FIGS. 3 and 4, the backlight unit 20 may include an optical layer 30 and an optical sheet 40. The optical layer 30 may include a substrate 32, at least one light source 34, a reflective sheet 36, and a diffusion plate 39.

The substrate 32 may be coupled to the front surface of the frame 60. The substrate 32 may have the shape of a plate, or may be configured as a plurality of straps spaced apart from each other in the vertical direction. The substrate 32 may be made of at least one of polyethylene terephthalate (PET), glass, polycarbonate (PC), or silicon. The substrate 32 may be a printed circuit board (PCB).

At least one light source 34 may be mounted on the substrate 32. A plurality of light sources 34 may be spaced apart from each other on the substrate 32. An electrode pattern for connecting an adapter and the light source 34 may be formed on the substrate 32. For example, a carbon nanotube (CNT) electrode pattern may be formed on the substrate 34 to connect the light source 34 and the adapter.

For example, the light source 34 may be a light emitting diode (LED) chip or an LED package including at least one LED chip. The light source 34 may consist of a colored LED that emits at least one of red, green or blue light, or a white LED. The colored LED may include at least one of a red LED, a green LED, or a blue LED. The light source 34 may be referred to as a light assembly 34.

The reflective sheet 36 may be positioned at the front of the substrate 32. The reflective sheet 36 may be positioned on an area of the substrate 32 other than an area where the light source 34 is provided. The reflective sheet 36 may include a hole 36a in which the light source 34 is positioned.

In addition, the reflective sheet 36 may include at least one of metal or metal oxide as a reflective material. For example, the reflective sheet 36 may include a metal and/or a metal oxide having a high reflectance such as at least one of aluminum (Al), silver (Ag), gold (Au), or titanium dioxide (TiO2). For example, resin may be deposited on or applied to the light source 34 and/or the reflective sheet 36. The resin may diffuse light of the light source 34. Accordingly, the reflective sheet 36 may reflect light, provided by the light source 34 or reflected by the diffusion plate 39, forward.

The diffusion plate 39 may be positioned at the front of the reflective sheet 36. The diffusion plate 39 may diffuse light from the light source 34. A spacer 36b may be positioned between the reflective sheet 36 and the diffusion plate 39, and may support a rear surface of the diffusion plate 39. Accordingly, an air gap may be formed between the reflective sheet 36 and the diffusion plate 39, and the air gap may allow the light from the light source 34 to spread widely.

The optical sheet 40 may be positioned at the front of the diffusion plate 39. A rear surface of the optical sheet 40 may be in close contact with the diffusion plate 39, and a front surface of the optical sheet 40 may be in close contact with or adjacent to a rear surface of the display panel 10. The optical sheet 40 may include a diffusion sheet and/or a prism sheet.

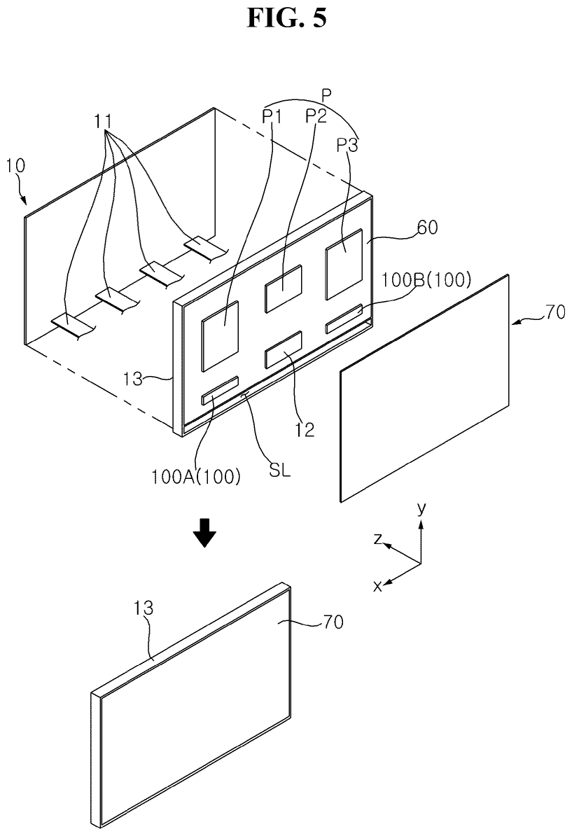

Referring to FIG. 5, a board P may be coupled to the frame 60. The board P may be positioned between the frame 60 and the back cover 70, and may be coupled to a rear surface of the frame 60. A plurality of electronic elements may be mounted on the board P. The board P may be a printed circuit board (PCB), and may be electrically connected to electronic components of the display device.

A power supply board P1 may supply power to each component of the display device. A main board P3 may control each component of the display device. A timing controller board P2 may be connected to the matin board P3 via a cable, and may provide an image (or video) signal to the display panel 10.

A cable 11 may be electrically connected to the display panel 10 at a position adjacent to a lower side of the display panel 10. The cable 11 may pass through a slit SL or a hole formed in the frame 60. A source PCB 12 may be coupled to the rear surface of the frame 60 at a position adjacent to a lower side of the frame 60, and may be electrically connected to the cable 11. The source PCB 12 may be electrically connected to the timing controller board P2 via a cable.

Accordingly, the timing controller board P2 may provide digital video data and a timing control signal to the display panel 10 via the source PCB 12.

A speaker 100 may be coupled to the frame 60. The speaker 100 may be positioned between the frame 60 and the back cover 70, and may be coupled to the rear surface of the frame 60. The speaker 100 may be adjacent to one side of the frame 60. The speaker 100 may be adjacent to the lower side of the frame 60, and may provide sound to the outside of the display device 1. For example, a plurality of speakers 100A and 100B may be coupled to the frame 60.

A sound device may include a speaker 100, a frame 60, and a component (a holder described later) for coupling the speaker 100 to the frame 60. The frame 60 may be the frame 60 of the display device described above. Alternatively, the frame 60 may be a frame of an audio device.

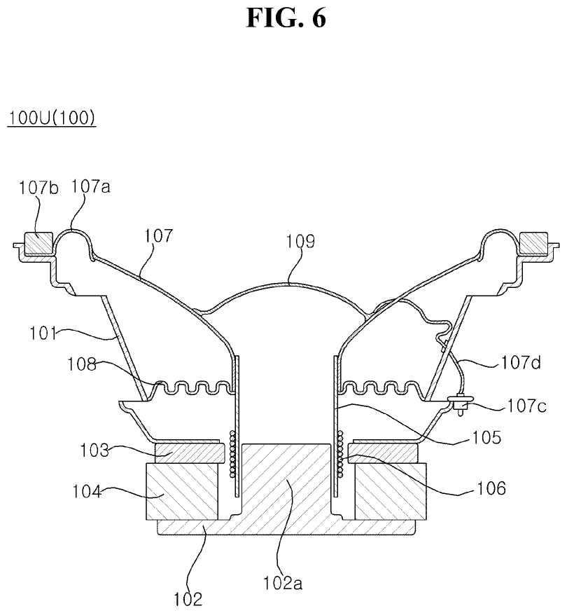

Referring to FIG. 6, a speaker frame 101 may support components of a speaker unit 100U of the speaker 100. The speaker frame 101 may be installed in a speaker box 101H of the speaker 100, which will be described later. The speaker 100 may be referred to as a speaker assembly 100 or a speaker module 100.

A first plate 102 may form one side of the speaker unit 100U. A pole piece 102a may protrude from a central portion of the first plate 102, and may have the shape of a hollow cylinder or a solid cylinder. A second plate 103 may be spaced apart from the first plate 102, and may have a ring shape. A portion of the pole piece 102a may pass through the second plate 103, and an air gap may be formed between the second plate 103 and the pole piece 102a.

A magnet 104 may be disposed between the first plate 102 and the second plate 103, and may have a ring shape. A portion of the pole piece 102a may pass through the magnet 104. A bobbin 105 may be positioned in the air gap between the pole piece 102a and the second plate 103 and an air gap between the pole piece 102a and the magnet 104, and may have a hollow cylindrical shape extending in a longitudinal direction of the pole piece 102a. A coil 106 may be formed on or wound around an outer circumferential surface of the bobbin 105, and may be referred to as a voice coil 106. A terminal 107c and a tinsel wire 107d may transfer electrical energy output from an amplifier to the coil 106.

A spider 108 may have elasticity. The spider 108 may be positioned between the bobbin 105 and the speaker frame 101, and may be coupled to the bobbin 105 and the speaker frame 101. The spider 108 may support the bobbin 105, and may be referred to as a damper 108.

One side of a diaphragm 107 may be coupled or attached to the bobbin 105, and the other side of the diaphragm 107 may be supported by an elastic edge 107a. For example, the diaphragm 107 may have the shape of a cone or dome. A gasket 107b may be provided on a lateral surface of the edge 107a, thereby preventing interference of surrounding mechanical components with the vibrating diaphragm 107. For example, a dust cap 109 may cover a central portion of the diaphragm 107, thereby preventing dust or the like from entering the inside of a magnetic circuit.

When magnetic field lines are formed in the air gap by the magnet 104 and current flows through the coil 106, a Lorentz force may be generated. The magnitude of the Lorentz force may be proportional to the magnitude of the magnetic field lines (magnetic flux density), the amount of the current and the length of the wound coil, and the direction of the force may act in a direction perpendicular to a plane defined by the magnetic flux density and the current.

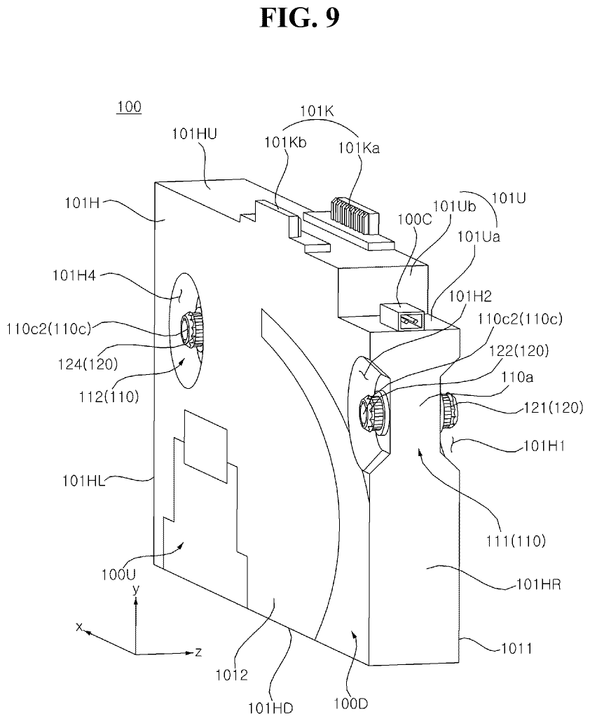

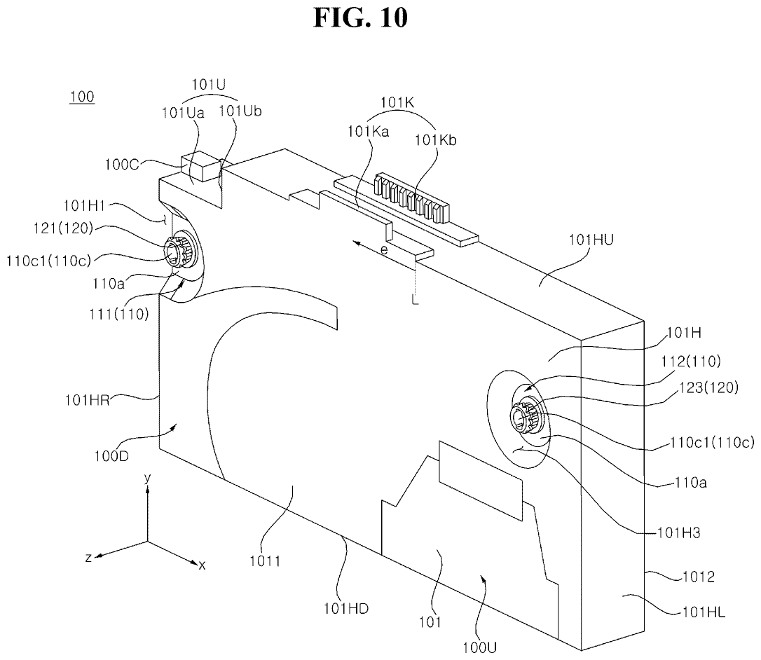

Accordingly, the diaphragm 107 may vibrate in the longitudinal direction of the pole piece 102a. In FIG. 6, a positive (+) sound pressure may be generated when the diaphragm 107 moves upward, and a negative (−) sound pressure may be generated when the diaphragm 107 moves downward, such that the speaker unit 100U may provide sound upward. The vibration of the diaphragm 107 may cause the air inside the speaker box 101H (see FIGS. 9 and 10) to resonate, thereby changing the pressure.

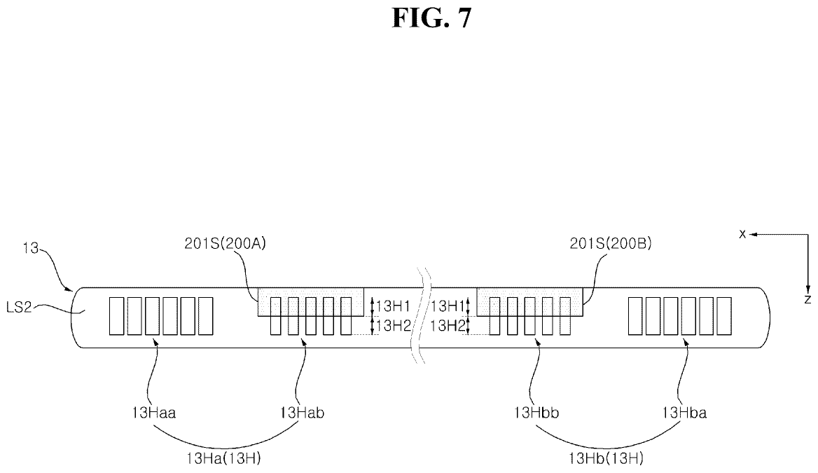

Referring to FIG. 7, a hole 13H may be formed in the side frame 13 at a position adjacent to the speaker 100 (see FIG. 5). For example, the speaker 100 may be adjacent to the second long side LS2, namely, the lower side of the display device 1, and the hole 13H may be formed in a portion of the side frame 13 that defines the second long side LS2. Sound output from the speaker 100 may be provided to the outside through the hole 13H. The hole 13H may consist of holes spaced apart from each other. A plurality of holes 13H may face the plurality of speakers 100.

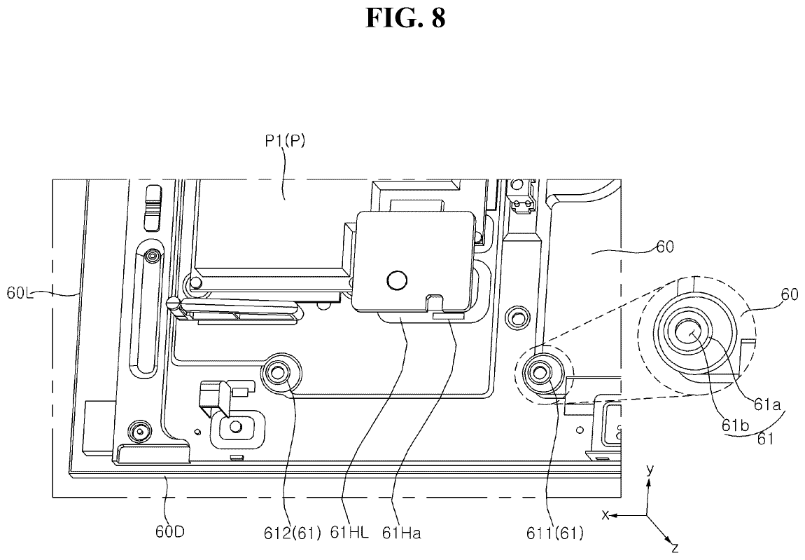

Referring to FIG. 8, a fixing portion 61 may be formed by being pressed rearward from a front surface of the frame 60. The fixing portion 61 may be referred to as a forming portion 61. A fixing hole 61b may be formed through the fixing portion 61. For example, a plurality of fixing portions 611 and 612 may be spaced apart from each other.

Referring to FIGS. 9 and 10, the components of the speaker unit 100U described above with reference to FIG. 6 may be mounted in the speaker box 101H of the speaker 100. The diaphragm 107 (see FIG. 6) of the speaker unit 100U may provide sound in a downward direction of the speaker box 101H. The speaker box 101H may be referred to as an enclosure 101H, a housing 101H, or a case 101H.

The speaker 100 may be adjacent to a lower side 60D (see FIG. 8) of the frame 60. A first speaker 100A may be disposed closer to a left side 60L than to a right side 60R of the frame 60, and a second speaker 100B may be disposed closer to the right side 60R than to the left side 60L of the frame 60 (refer to FIG. 1). A coupling portion 110 may be formed at one side of the speaker box 101H, and may be coupled to the fixing portion 61 (see FIG. 8) via a holder 120. For example, a plurality of coupling portions 111 and 112 may be spaced apart from each other, and may be coupled to the plurality of fixing portions 611 and 612 via a plurality of holders 121, 122, 123, and 124. Accordingly, the speaker 100 may be mounted to the rear of the frame 60.

A fixing portion 101K may protrude from one side of the speaker box 101H. The fixing portion 101K may have a hook shape. A first fixing portion 101Ka and a second fixing portion 101Kb may protrude from an upper side of the speaker box 101H, and may be spaced apart from each other in a thickness direction of the speaker box 101H. For example, the first fixing portion 101Ka and the second fixing portion 101Kb may face each other, and may be spaced apart from a vertical line L passing through the center of the speaker box 101H by a predetermined distance e. As another example, the first fixing portion 101Ka and the second fixing portion 101Kb may be arranged in a staggered manner with respect to each other.

A first insertion hole 61Ha (see FIG. 8) may be formed in the frame 60 adjacent to the left side 60L of the frame 60, and the first fixing portion 101Ka may be hook-coupled to the first insertion hole 61Ha.

A second insertion hole (not shown) may be formed in the frame 60 adjacent to the right side 60R of the frame 60, and the second fixing portion 101Kb may be hook-coupled to the second insertion hole.

In this case, the first and second fixing portions 101Ka and 101Kb may be arranged to be eccentric with respect to the vertical line passing through the center of the speaker box 101H or to be staggered with respect to each other, thereby preventing wrong insertion of the first and second fixing portions 101Ka and 101Kb into the first and second insertion holes 61Ha.

Meanwhile, the fixing portion 101K may be omitted, and in this case, the speaker 100 may be mounted to the frame 60 only via the holder 120.

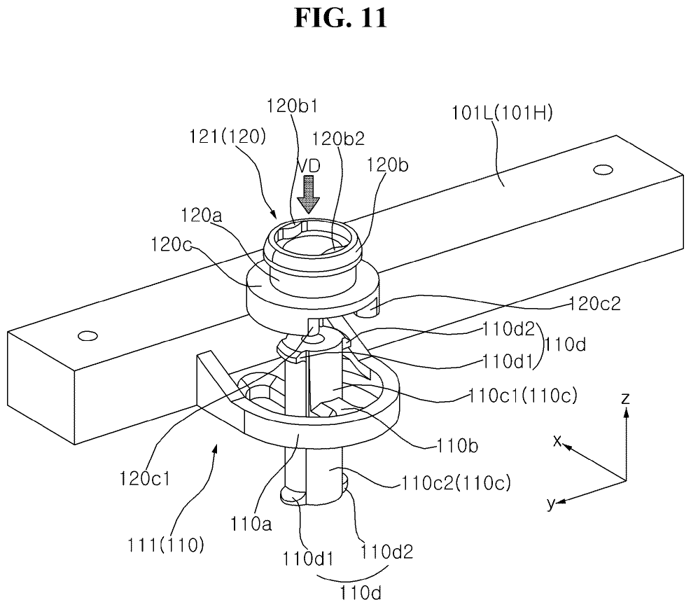

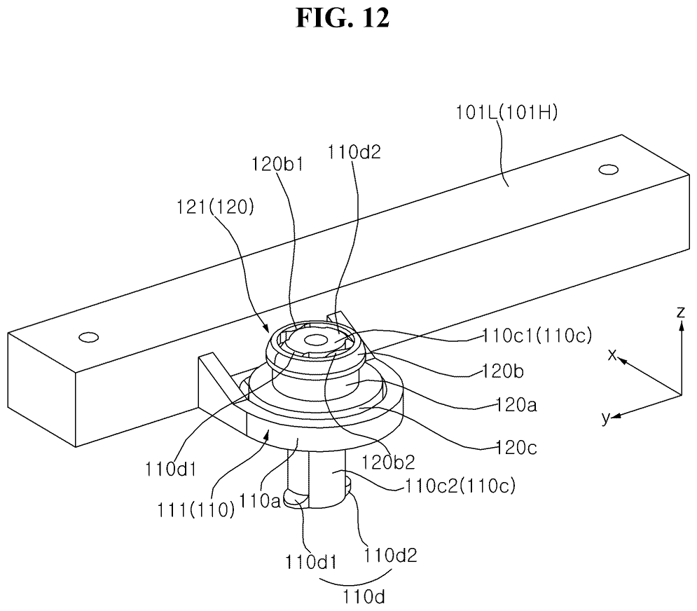

Referring to FIGS. 11 and 12, the coupling portion 110 may be formed at one side 101L of the speaker box 101H. The coupling portion 110 may include a base 110a, a bridge 110b, and a protruding portion 110c.

The base 110a may generally have a ring shape. The bridge 110b may cross the base 110a, and may be coupled to an inner circumferential surface of the base 110a. A plurality of holes 110b1 and 110b2 may be formed through the base 110a. The first hole 110b1 may be positioned opposite the second hole 110b2 with respect to the bridge 110b.

The protruding portion 110c may protrude from a central portion of the bridge 110b in a direction that intersects the bridge 110b. The protruding portion 110c may extend in the front-rear direction. The protruding portion 110c may be referred to as a boss 110c. A first protruding portion 110c1 may protrude forward from the bridge 110b, a second protruding portion 110c2 may protrude rearward from the bridge 110b. The first and second protruding portions 110c1 and 110c2 may be located on the same straight line, and may have the same shape.

A stopper 110d may protrude from an end of the protruding portion 110c in a direction that intersects the protruding portion 110c. The stopper 110d may be formed at an end of each of the first and second protruding portions 110c1 and 110c2. The stoppers 110d1 and 110d2 may be spaced apart from each other in a circumferential direction of the protruding portion 110c. The stopper 110d may be referred to as a hook 110d.

The holder 120 may include a body 120c, a neck 120a, and a head 120b. The holder 120 may have elasticity. The holder 120 may include a soft material such as rubber, silicone, etc. Accordingly, vibration of the speaker 100, which is coupled to the frame 60, may be suppressed from being transmitted to the frame 60 through the holder 120.

The body 120c may have a ring shape. A diameter of the body 120c may be less than a diameter of the base 110a. A plurality of legs 120c1 and 120c2 may protrude from one surface of the body 120c that faces the base 110a toward the plurality of holes 110b1 and 110b2. The first leg 120c1 may be aligned with the first hole 110b1, and may have a shape corresponding to the first hole 110b1. The second leg 120c2 may be aligned with the second hole 110b2, and may have a shape corresponding to the second hole 110b2.

The neck 120a may protrude from the other surface of the body 120c in a longitudinal direction of the body 120c. A diameter of the neck 120a may be less than the diameter of the body 120c. That is, a step may be formed between the neck 120a and the body 120c.

The head 120b may be positioned opposite the body 120c with respect to the neck 120a. The head 120b may protrude from an end of the neck 120a in a radial direction of the neck 120a, and may extend in a circumferential direction of the neck 120a. A diameter of the head 120b may be greater than the diameter of the neck 120a. That is, a step may be formed between the head 120b and the neck 120a.

The first holder 121 may be aligned with the first protruding portion 110c1, and may be positioned on the base 110a. The first protruding portion 110c1 may pass through the body 120c, the neck 120a, and the head 120b of the first holder 121, and a portion of the body 120c between the first and second legs 120c1 and 120c2 may be engaged with the bridge 110b. The first and second legs 120c1 and 120c2 of the first holder 120 may be inserted into the first and second holes 110b1 and 110b2. The first protruding portion 110c1 may be press-fitted into the first holder 121. The first and second stoppers 110d1 and 110d2 may be engaged with (or caught on) the end of the neck 120a within the head 120b. First and second protrusions 120b1 and 120b2 may protrude from an inner circumferential surface of the head 120b toward the first protruding portion 110c1, and may be adjacent to an outer circumferential surface of the first protruding portion 110c1. The first and second protrusions 120b1 and 120b2 may be disposed alternately with the first and the second stoppers 110d1 and 110d2.

Accordingly, the first holder 121 may be detachably coupled to the first protruding portion 110c1. The first holder 121 may be engaged with the bridge 110b and the stoppers 110d1 and 110d2 and fixed or secured to the coupling portion 110.

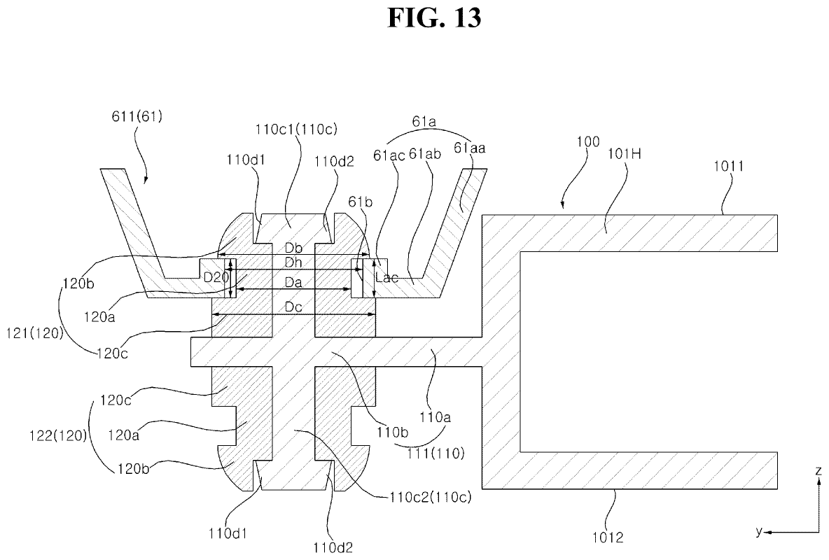

Referring to FIG. 13 along with FIGS. 9 and 10, the plurality of holders 121, 122, 123, and 124 may have the same shape. The coupling structure of the first holder 121 and the first protruding portion 110c1 described above with reference to FIGS. 11 and 12 may be equally applied to the coupling structure of the remaining holders 122, 123, 124 and the remaining protruding portions 110c2, 110c3, 110c4.

The coupling portion 110 may include a plurality of coupling portions 111 and 112. The plurality of coupling portions 111 and 112 may each include the base 110a, the bridge 110b, the protruding portion 110c, and the stopper 110d described above.

The first coupling portion 111 may be formed at one side of the speaker box 101H. The first coupling portion 111 may be positioned at or adjacent to one side 101 HR of the speaker box 101H. The first holder 121 may be detachably coupled to a first protruding portion 110c1 of the first coupling portion 111. The second holder 122 may be detachably coupled to a second protruding portion 110c2 of the first coupling portion 111. The first and second holders 121 and 122 may be symmetrical with respect to the base 110a of the first coupling portion 111. The first and second holders 121 and 122 may be disposed in front of and behind the base 110a, respectively.

The second coupling portion 112 may be formed on the other side of the speaker box 101H. The second coupling portion 112 may be positioned at or adjacent to the other side 101HL of the speaker box 101H. The third holder 123 may be detachably coupled to a first protruding portion 110c1 of the second coupling portion 112. The fourth holder 124 may be detachably coupled to a second protruding portion 110c2 of the second coupling portion 112. The third and fourth holders 123 and 124 may be symmetrical with respect to the base 110a of the second coupling portion 112. The third and fourth holders 123 and 124 may be disposed in front of and behind the base 110a, respectively.

The first and third holders 121 and 123 may be positioned at a first surface 1011 of the speaker box 101H. The first surface 1011 may be a front surface of the speaker box 101H. A first groove 101H1 may be formed by being recessed from the first surface 1011 of the speaker box 101H toward the base 110a of the first coupling portion 111. The first holder 121 may be positioned in the first groove 101H1, and the first groove 101H1 may be formed along a lateral surface of the first holder 121. A third groove 101H3 may be formed by being recessed from the first surface 1011 of the speaker box 101H toward the base 110a of the second coupling portion 112. The third holder 123 may be positioned in the third groove 101H3, and the third groove 101H3 may be formed along a lateral surface of the third holder 123.

The second and fourth holders 122 and 124 may be positioned at a second surface 1012 of the speaker box 101H. The second surface 1012 may be a rear surface of the speaker box 101H. A second groove 101H2 may be formed by being recessed from the second surface 1012 of the speaker box 101H toward the base 110a of the first coupling portion 111. The second holder 122 may be positioned in the second groove 101H2, and the second groove 101H2 may be formed along a lateral surface of the second holder 122. A fourth groove 101H4 may be formed by being recessed from the second surface 1012 of the speaker box 101H toward the base 110a of the second coupling portion 112. The fourth holder 124 may be positioned in the fourth groove 101H4, and the fourth groove 101H4 may be formed along a lateral surface of the fourth holder 124.

Accordingly, the holders 121, 122, 123, and 124 may be mounted to the front and rear surfaces of the speaker box 101H. The holder 120 may be coupled to the fixing portion 61 of the frame 60. The distance between the holders 121, 122, 123, and 124 may be constant regardless of the size of the speaker box 101H. That is, the holders 121, 122, 123, and 124 may be fixed at specific positions of the speaker box 10H of various sizes, and correspondingly, the positions of the fixing portions 61 of the frame 60 may be constant. In other words, the speaker box 101H of various sizes may be mounted to the fixing portions 61 formed at specific positions of the frame 60, allowing the fixing portions 61 to be commonly used for the speaker box 101H of various shapes.

The fixing portion 61 may include a fixing body 61a and a fixing hole 61b. The fixing body 61 may generally have the shape of a truncated cone. The fixing body 61a may include an inclined portion 61aa, a horizontal portion 61ab, and a vertical portion 61ac. The inclined portion 61aa may protrude rearward from a rear surface of the frame 60, and may have a diameter that decreases with increasing distance from the rear surface. The horizontal portion 61ab may be bent from an end of the inclined portion 61aa to the inside of the inclined portion 61aa, and may have a ring shape parallel to the rear surface of the frame 60. The vertical portion 61ac may be bent from an end of the horizontal portion 61ab toward the rear surface of the frame 60. The horizontal portion 61ab and the vertical portion 61ac may define a boundary of the fixing hole 61b.

A diameter Da of the neck 120a of the holder 120 may be equal to or less than a diameter Dh of the fixing hole 61b. A diameter Db of the head 120b of the holder 120 may be greater than the diameter Dh of the fixing hole 61b. A diameter Dc of the body 120c of the holder 120 may be greater than the diameter Dh of the fixing hole 61b. A distance D20 between the body 120c and the head 120b, which is a length of the neck 120a, may be equal to or greater than a length Lac of the vertical portion 61ac. When the neck 120a and the head 120b are inserted into the fixing portion 61 through the fixing hole 61b, the neck 120a may be positioned in the fixing hole 61b, the body 120c may be engaged with the horizontal portion 61ab, and the head 120b may be engaged with the vertical portion 61ac. That is, the holder 120 may be detachably coupled to the fixing portion 61.

For example, the first surface 1011 of the speaker box 101H may face the rear surface of the frame 60 (see FIG. 8). In this case, the first holder 121 may be coupled to the first fixing portion 611, and the third holder 123 may be coupled to the second fixing portion 612. Accordingly, the speaker 100 may be mounted to the frame 60.

As another example, the second surface 1012 of the speaker box 101H may face the rear surface of the frame 60 (see FIG. 8). In this case, the second holder 122 may be coupled to the second fixing portion 612, and the fourth holder 124 may be coupled to the first fixing portion 611. Accordingly, the speaker 100 may be mounted to the frame 60.

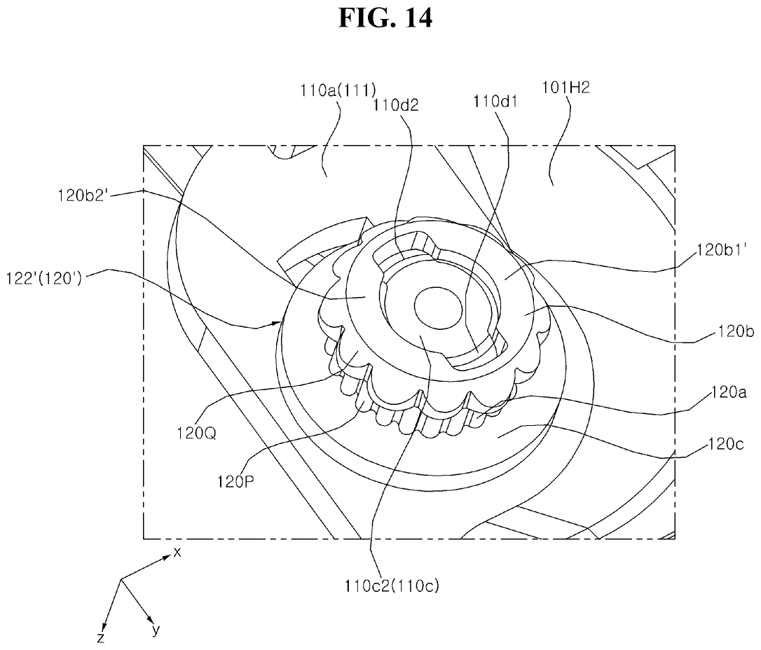

Referring to FIG. 14, unlike the holder 120 described above, first and second protrusions 120b1′ and 120b2′ of a holder 120′ may be formed in an arc shape along an outer circumferential surface of the protruding portion 110c, and may be adjacent to the outer circumferential surface of the protruding portion 110c. In addition, serrated protrusions 120P may be formed on a lateral surface of a neck 120a, allowing the neck 120a of the holder 120′ to be in close contact with the vertical portion 61ac (see FIG. 13). In addition, serrated protrusions 120Q may be formed on a lateral surface of a head 120b.

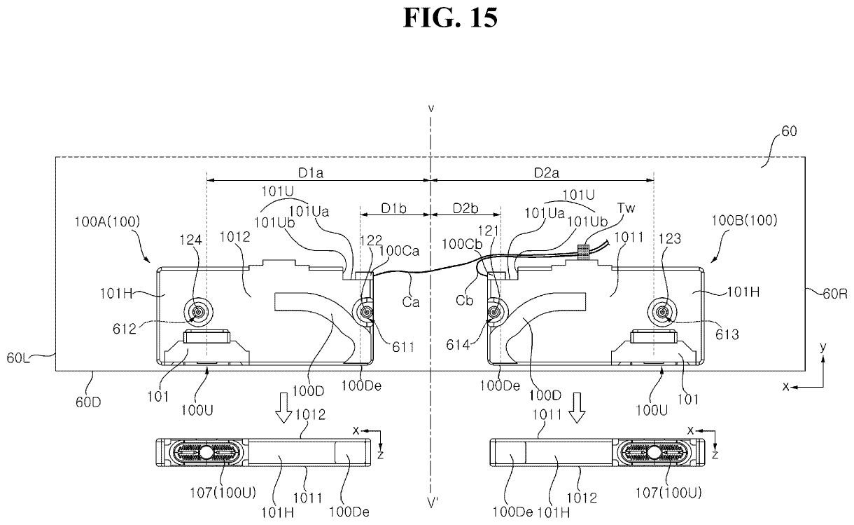

Referring to FIG. 15, the speakers 100 may be positioned at the rear of the frame 60.

The first speaker 100A may be adjacent to the lower side 60D of the frame 60. The first speaker 100A may be positioned to the left of a vertical line VV′ passing through the center of the frame 60. The first surface 1011 of the first speaker 100A may face the rear surface of the frame 60, and the second surface 1012 of the first speaker 100A may form a rear surface of the first speaker 100A.

The second speaker 100B may be adjacent to the lower side 60D of the frame 60. The second speaker 100B may be positioned to the right of the vertical line VV′ passing through the center of the frame 60. The second surface 1012 of the second speaker 100B may face the rear surface of the frame 60, and the first surface 1011 of the second speaker 100B may form a rear surface of the second speaker 100B.

The first and second speakers 100A and 100B are in a 180-degree inverted [rotated; reversed; flipped] relationship with respect to the vertical line VV′ between the first and second speakers 100A and 100B.

The first holder 121 of the first speaker 100A may be coupled to the first fixing portion 611, and the third holder 123 of the first speaker 100A may be coupled to the second fixing portion 612.

The second holder 122 of the second speaker 100B may be coupled to a fourth fixing portion 614, and the fourth holder 124 of the second speaker 100B may be coupled to a third fixing portion 613. Here, the third and fourth fixing portions 613 and 614 may have the same shape as the first and second fixing portions 611 and 612, and a distance between the third and fourth fixing portions 613 and 614 may be equal to a distance between the first and second fixing portions 611 and 612.

Accordingly, the first and second speakers 100A and 100B may be mounted to the frame 60. The first and second speakers 100A and 100B may be a single type of speaker 100 that differs only in their arrangement with respect to the frame 60.

The speaker unit 100U may be positioned at the lower side of the speaker box 101H, and the diaphragm 107 of the speaker unit 100U may provide sound downward. For example, the speaker unit 100U may be a full range speaker unit. Air inside the speaker box 101H may vibrate in response to the operation of the speaker unit 100U. A duct 100D may be installed inside the speaker unit 101H, and may define a flow path through which the air inside the speaker box 101H passes. An outlet 100De of the duct 100D may be formed at the lower side of the speaker box 101H, and may be spaced apart from the speaker unit 100U. The duct 100D may provide sound in a low-frequency band in a downward direction. The speaker unit 100U, which outputs relatively high-frequency sound, may be positioned on an outer side relative to the duct 100D.

A distance D1a between the speaker unit 100U of the first speaker 100A and the vertical line VV′ may be greater than a distance D1b between the outlet 100De of the duct 100D of the speaker 100A and the vertical line VV′. A distance D2a between the speaker unit 100U of the second speaker 100B and the vertical line VV′ may be greater than a distance D2b between the outlet 100De of the duct 100D of the second speaker 100B and the vertical line VV′. For example, the distances D1a and D2a may be the same, and the distances D1b and D2b may be the same. In this case, the sound provided by the first and second speakers 100A and 100B may be symmetrical. In addition, as the speaker units 100U of the first and second speakers 100A and 100B are arranged at a greater distance from each other, stereo separation of the sound may be improved.

A groove 101U may be formed on an upper side of the speaker box 101H. The groove 101U may include a horizontal surface 101Ua and a vertical surface 101Ub. A cable connector 100C may be mounted in the groove 101U. The groove 101U of the first speaker 100A may be formed on or adjacent to a right side of the speaker box 101H. The groove 101U of the second speaker 100B, which is 180 degrees inverted from the first speaker 100A with respect to the vertical line VV′, may be formed on or adjacent to a left side of the speaker box 101H.

A first cable connector 100Ca may be mounted on the horizontal surface 101Ua or the vertical surface 101Ub of the groove 101U of the first speaker 100A. One end of a first cable Ca may be coupled to the first cable connector 100Ca, and the first cable Ca may be electrically connected to the first speaker 100A via the first cable connector 100Ca. The other end of the first cable Ca may be electrically connected to an amplifier. The amplifier may be provided on the main board P3 (see FIG. 5).

A second cable connector 100Cb may be mounted on the horizontal surface 101Ua or the vertical surface 101Ub of the groove 101U of the second speaker 100B. One end of a second cable Cb may be coupled to the second cable connector 100Cb, and the second cable Cb may be electrically connected to the second speaker 100B via the second cable connector 100Cb. The other end of the second cable Cb may be electrically connected to an amplifier. The amplifier may be provided on the main board P3 (see FIG. 5).

A user may hold the first and second cables Ca and Cb and fix them to the frame 60 using an adhesive member Tw such as tape. The first and second cables Ca and Cb may each be referred to as a cable C. The adhesive member Tw may be attached to the rear surface of the frame 60, and portions of the first and second cables Ca and Cb may be fixed between the frame 60 and the adhesive member Tw. However, when wiring the first and second cables Ca and Cb in this manner, not only does it require a separate member such as the adhesive member Tw, but it also requires the user to handle both the cables and the adhesive member, which may make the wiring operation difficult.

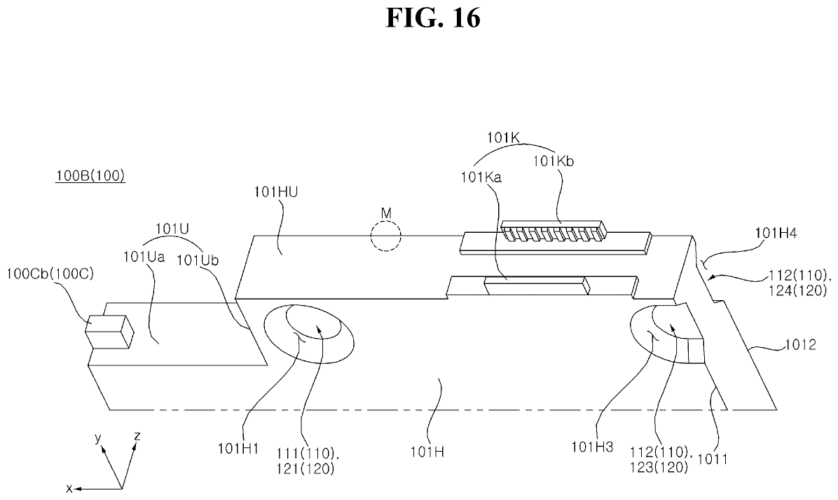

The coupling portions 110 and the holders 121, 122, 123, and 124 described above with reference to FIGS. 9 and 10 may be schematically shown in FIG. 16 and subsequent figures. The positions of the coupling portions 110 and the holders 121, 122, 123, and 124 may vary.

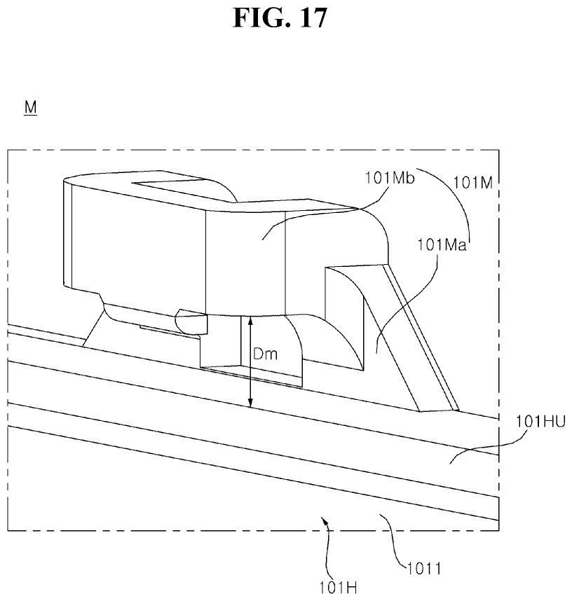

Referring to FIGS. 16 and 17, the second speaker 100B may further include a hook 101M in addition to the fixing portion 101K. The hook 101M may be formed on an upper side 101HU of the speaker box 101H of the second speaker 100B. The hook 101M may be adjacent to a front end of the upper side 101HU. An extension portion 101Ma of the hook 101M may protrude upward from the front end of the upper side 101HU, and a protruding portion 101Mb of the hook 101M may be bent rearward from the extension portion 101Ma. For example, a protruding height of the hook 101M with respect to the upper side 101HU may be 15 mm. The first speaker 100A (see FIG. 15) may correspond to the second speaker 100B inverted 180 degrees, and the hook 101M of the second speaker 100B may be adjacent to a rear end of the upper side 101HU.

A user may place the first and second cables Ca and Cb (see FIG. 15) in an overlapping manner and hook them onto the hook 101M of the second speaker 100B. However, when wiring the first and second cables Ca and Cb in this manner, since the user should hold the cables from both sides of the hook 101M, and the hook 101M of the second speaker 100B is positioned close to the rear surface of the frame 60, the wiring operation may be difficult for the user. With respect to the first and second speakers 100A and 100B that are in a 180-degree inverted relationship, the hook 101M positioned offset to one side (i.e., the front end or rear end) of the speaker box 101H may be disadvantageous for cable wiring.

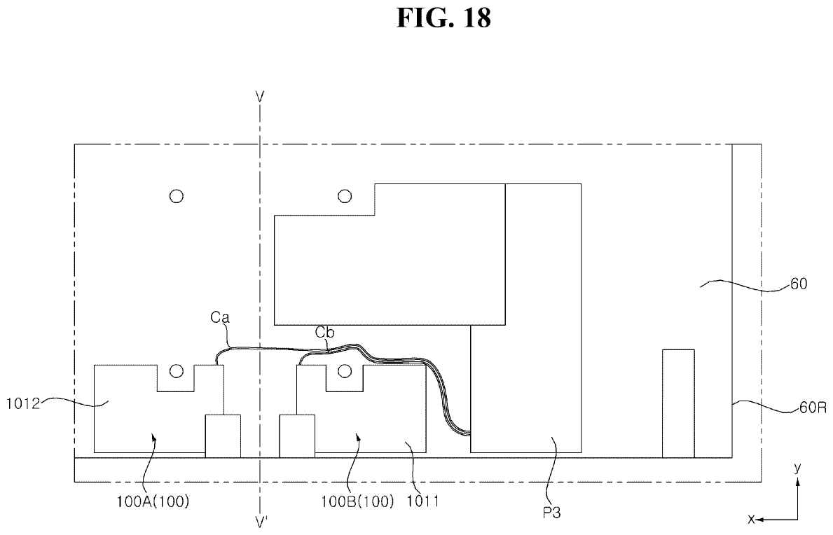

Referring to FIG. 18, the first and second speakers 100A and 100B may be in a 180-degree inverted relationship with respect to a vertical line VV′ between the first and second speakers 100A and 100B. A first cable Ca may be electrically connected to the first speaker 100A, and a second cable Cb may be electrically connected to the second speaker 100B. The first and second cables Ca and Cb may be electrically connected to the amplifier of the main board P3. A user may hook the first and second cables Ca and Cb onto the second speaker 100B and/or the first speaker 100A, which will be described in more detail later.

The first and second speakers 100A and 100B described above and below may be mounted to the fixing portions 61 of the frame 60 via the coupling portions 110 and the holders 121, 122, 123, and 124.

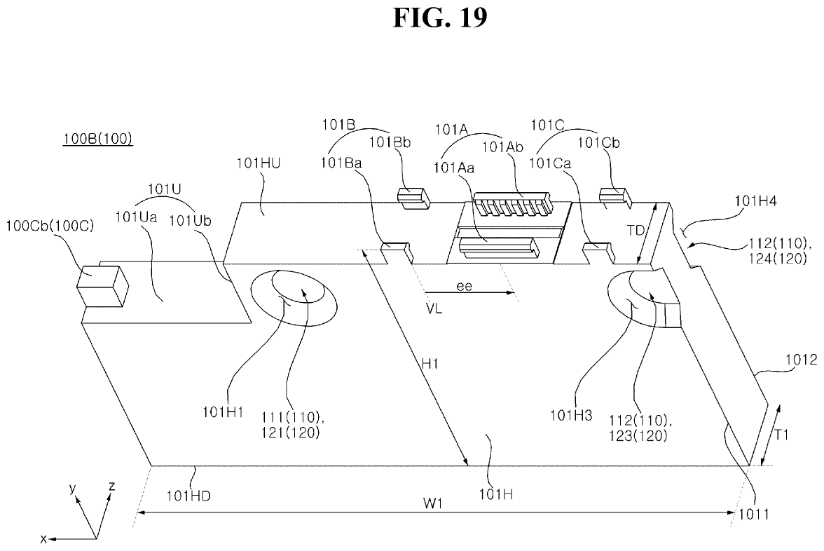

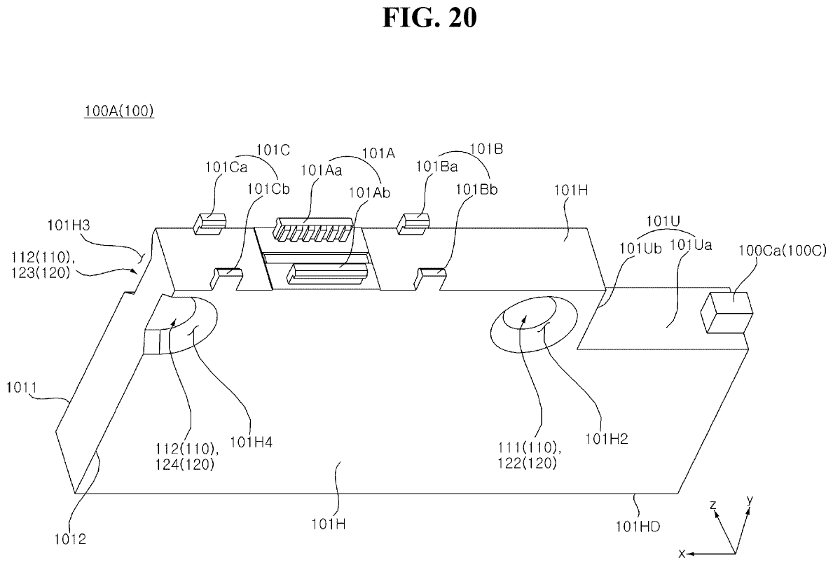

Referring to FIGS. 19 and 20, the second speaker 100B may include a fixing portion 101A and a support portion 101B, 101C. The fixing portion 101A and the support portion 101B, 101C may each have a hook shape.

The fixing portion 101A may protrude from one side of the speaker box 101H of the second speaker 100B. The fixing portion 101A may protrude from an upper side 101HU of the speaker box 101H. A pair of fixing portions 101Aa and 101Ab may be spaced apart from each other in a thickness direction TD of the speaker box 101H. The first fixing portion 101Aa may be adjacent to a rear end of the upper side 101HU, and the second fixing portion 101Ab may be adjacent to a front end of the upper side 101HU. The pair of fixing portions 101Aa and 101Ab may be spaced apart from a vertical line VL passing through the center of the speaker box 101H by a predetermined distance ee. The pair of fixing portions 101Aa and 101Ab may face each other in the thickness direction TD of the speaker box 101H. Alternatively, the pair of fixing portions 101Aa and 101Ab may be arranged in a staggered manner with respect to each other.

The support portion 101B, 101C may protrude from the one side of the speaker box 101H where the fixing portion 101A is formed. The support portion 101B, 101C may protrude from the upper side 101HU of the speaker box 101H. The support portion 101B, 101C may include an inner support portion 101B and an outer support portion 101C that are spaced apart from each other with the fixing portion 101A interposed therebetween.

The inner support portion 101B may be spaced apart from the fixing portion 101A in a width direction (i.e., a left-right direction) of the speaker box 101H. The inner support portion 101B may be positioned closer to the center of the upper side 101H than the fixing portion 101A. A pair of inner support portions 101Ba and 101Bb may be spaced apart from each other in the thickness direction TD of the speaker box 101H. The first inner support portion 101Ba may be adjacent to the rear end of the upper side 101HU. The second inner support portion 101Bb may be adjacent to the front end of the upper side 101HU. The pair of inner support portions 101Ba and 101Bb may face each other in the thickness direction TD of the speaker box 101H. Alternatively, the pair of inner support portions 101Ba and 101Bb may be arranged in a staggered manner with respect to each other.

The outer support portion 101C may be spaced apart from the fixing portion 101A in the width direction (i.e., the left-right direction) of the speaker box 101H. The outer support portion 101C may be positioned farther from the center of the upper side 101H than the fixing portion 101A. A pair of outer support portions 101Ca and 101Cb may be spaced apart from each other in the thickness direction TD of the speaker box 101H. The first outer support portion 101Ca may be adjacent to the rear end of the upper side 101HU. The second outer support portion 101Cb may be adjacent to the front end of the upper side 101HU. The pair of outer support portions 101Ca and 101Cb may face each other in the thickness direction TD of the speaker box 101H. Alternatively, the pair of outer support portions 101Ca and 101Cb may be arranged in a staggered manner with respect to each other.

The first speaker 100A may correspond to the second speaker 100B inverted 180 degrees with respect to a vertical line VV′ (see FIG. 18) between the first and second speakers 100A and 100B. The first fixing portion 101Aa of the first speaker 100A may be adjacent to the front end of the upper side 101HU, and the second fixing portion 101Ab thereof may be adjacent to the rear end of the upper side 101HU. The first inner support portion 101Ba of the first speaker 100A may be adjacent to the front end of the upper side 101HU, and the second inner support portion 101Bb thereof may be adjacent to the rear end of the upper side 101HU. The first outer support portion 101Ca of the first speaker 100A may be adjacent to the front end of the upper side 101HU, and the second outer support portion 101Cb thereof may be adjacent to the rear end of the upper side 101HU.

Accordingly, the second speaker 100B (see FIG. 19) may have the fixing portion 101Aa, which is adjacent to a rear surface of the second speaker 100B, namely, the first surface 1011, and the support portions 101Ba and 101Ca. In addition, the first speaker 100A (see FIG. 20) may have the fixing portion 101Ab, which is adjacent to a rear surface of the first speaker 100A, namely, the second surface 1012, and the support portions 101Bb and 101Cb.

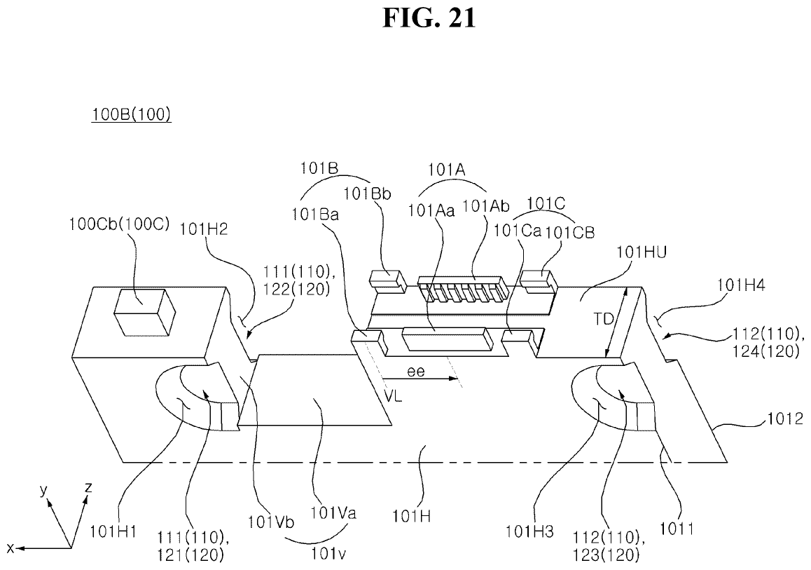

Referring to FIG. 21, a groove 101V may be formed from the upper side 101HU of the speaker box 101H to the inside of the speaker box 101H. The groove 101V may be spaced apart from left and right surfaces of the speaker box 101H. The groove 101V may include a horizontal surface 101Va and a vertical surface 101Vb. The cable connector 100C may be mounted on the upper side 101HU. Alternatively, the cable connector 100C may be mounted on the horizontal surface 101Va or the vertical surface 101Vb.

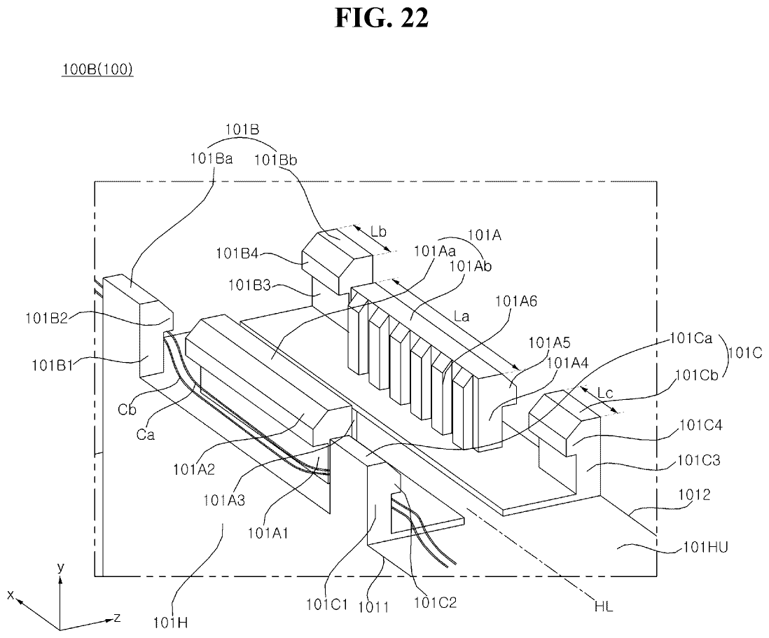

Referring to FIG. 22, the first fixing portion 101Aa, the first inner support portion 101Ba, and the first outer support portion 101Ca may be referred to as a first wiring set (101Aa, 101Ba, 101Ca) or a first holding set (101Aa, 101Ba, 101Ca). The second fixing portion 101Ab, the second inner support portion 101Bb, and the second outer support portion 101Cb may be referred to as a second wiring set (101Ab, 101Bb, 101Cb) or a second holding set (101Ab, 101Bb, 101Cb). A horizontal line HL may extend horizontally (i.e., the left-right direction) while passing through the center of the upper side 101HU of the speaker box 101H.

The first wiring set (101Aa, 101Ba, 101Ca) may be adjacent to the first surface 1011 of the second speaker 100B. For example, the first fixing portion 101Aa may be disposed closer to the horizontal line HL than the first support portions 101Ba and 101Ca. As another example, the first fixing portion 101Aa may be disposed farther from the horizontal line HL than the first support portions 101Ba and 101Ca. The first inner support portion 101Ba, the first fixing portion 101Aa, and the first outer support portion 101Ca may be arranged in a zigzag manner.

The first fixing portion 101Aa may include an extension portion 101A1 and a protruding portion 101A2. The extension portion 101A1 may protrude upward from the upper side 101HU of the speaker box 101H. The protruding portion 101A2 may be adjacent to an end (i.e., an upper end) of the extension portion 101A1, and may protrude from the extension portion 101A1 in a first direction intersecting the extension portion 101A1. The protruding portion 101A2 may be bent from the end of the extension portion 101A1 in the first direction. For example, the first fixing portion 101Aa may be disposed closer to the horizontal line HL than the first support portions 101Ba and 101Ca, and the first direction may be a direction from the extension portion 101A1 toward a space between the first support portions 101Ba and 101Ca, namely, a direction from the second surface 1012 toward the first surface 1011. As another example, the first fixing portion 101Aa may be disposed farther from the horizontal line HL than the first support portions 101Ba and 101Ca, and the first direction may be a direction from the extension portion 101A1 toward a space between the first support portions 101Ba and 101Ca, namely, a direction from the first surface 1011 toward the second surface 1012.

Ribs 101A3 may protrude from one surface of the extension portion 101A1 that is opposite to the protruding portion 101A2. The ribs 101A3 may be spaced apart from each other along the extension portion 101A1.

The first inner support portion 101Ba may include an extension portion 101B1 and a protruding portion 101B2. The extension portion 101B1 may protrude upward from the upper side 101HU of the speaker box 101H. The protruding portion 101B2 may be adjacent to an end (i.e., an upper end) of the extension portion 101B1, and may protrude from the extension portion 101B1 in a second direction intersecting the extension portion 101B1. The protruding portion 101B2 may be bent from the end of the extension portion 101B1 in the second direction. The second direction may be opposite to the first direction. A length Lb of the first inner support portion 101Ba may be less than a length La of the first fixing portion 101Aa.

The first outer support portion 101Ca may include an extension portion 101C1 and a protruding portion 101B2. The extension portion 101C1 may protrude upward from the upper side 101HU of the speaker box 101H. The protruding portion 101C2 may be adjacent to an end (i.e., an upper end) of the extension portion 101C1, and may protrude from the extension portion 101C1 in the second direction intersecting the extension portion 101C1. The protruding portion 101C2 may be bent from the end of the extension portion 101C1 in the second direction. The second direction may be opposite to the first direction. A length Lc of the first outer support portion 101Ca may be less than the length La of the first fixing portion 101Aa.

The second wiring set (101Ab, 101Bb, 101Cb) may be adjacent to the second surface 1012 of the second speaker 100B. For example, the second fixing portion 101Ab may be disposed closer to the horizontal line HL than the second support portions 101Bb and 101Cb. As another example, the second fixing portion 101Ab may be disposed farther from the horizontal line HL than the second support portions 101Bb and 101Cb. The second inner support portion 101Bb, the second fixing portion 101Ab, and the second outer support portion 101Cb may be arranged in a zigzag manner.

The second fixing portion 101Ab may include an extension portion 101A4 and a protruding portion 101A5. The extension portion 101A4 may protrude upward from the upper side 101HU of the speaker box 101H. The protruding portion 101A5 may be adjacent to an end (i.e., an upper end) of the extension portion 101A4, and may protrude from the extension portion 101A4 in a third direction intersecting the extension portion 101A4. The protruding portion 101A5 may be bent from the end of the extension portion 101A4 in the third direction. For example, the second fixing portion 101Ab may be disposed closer to the horizontal line HL than the second support portions 101Bb and 101Cb, and the third direction may be a direction from the extension portion 101A4 toward a space between the second support portions 101Bb and 101Cb, namely, a direction from the first surface 1011 toward the second surface 1012. As another example, the second support portion 101Ab may be disposed farther from the horizontal line HL than the second support portions 101Bb and 101Cb, and the third direction may be a direction from the extension portion 101A4 toward a space between the second support portions 101Bb and 101Cb, namely, a direction from the second surface 1012 toward the first surface 1011.

Ribs 101A6 may protrude from one surface of the extension portion 101A4 that is opposite to the protruding portion 101A5. The ribs 101A6 may be spaced apart from each other along the extension portion 101A4.

The second inner support portion 101Bb may include an extension portion 101B3 and a protruding portion 101B4. The extension portion 101B3 may protrude upward from the upper side 101HU of the speaker box 101H. The protruding portion 101B4 may be adjacent to an end (i.e., an upper end) of the extension portion 101B3, and may protrude from the extension portion 101B3 in a fourth direction intersecting the extension portion 101B3. The protruding portion 101B4 may be bent from the end of the extension portion 101B3 in the fourth direction. The fourth direction may be opposite to the third direction. A length Lb of the second inner support portion 101Bb may be less than a length La of the second fixing portion 101Ab.

The second outer support portion 101Cb may include an extension portion 101C3 and a protruding portion 101C4. The extension portion 101C3 may protrude upward from the upper side 101HU of the speaker box 101H. The protruding portion 101C4 may be adjacent to an end (i.e., an upper end) of the extension portion 101C3, and may protrude from the extension portion 101C3 in the fourth direction intersecting the extension portion 101C3. The protruding portion 101C4 may be bent from the end of the extension portion 101C3 in the fourth direction. The fourth direction may be opposite to the third direction. A length Lc of the second outer support portion 101Cb may be less than the length La of the second fixing portion 101Ab.

For example, the first wiring set (101Aa, 101Ba, 101Ca) and the second wiring set (101Ab, 101Bb, 101Cb) may be symmetrical with respect to the horizontal line HL.

A user may place first and second cables Ca and Cb between the first fixing portion 101Aa and the first support portions 101Ba and 101Ca. The first and second cables Ca and Cb may be bent between the extension portions 101B1, 101A1, and 101C1, and may be engaged with (or caught on) the extension portions 101B1, 101A1, and 101C1. Portions of the bent first and second cables Ca and Cb may be under tension. In addition, the first and second cables Ca and Cb may be engaged with the protruding portions 101B2, 101A2, 101C2, thereby restricting upward movement.

In this manner, when wiring the first and second cables Ca and Cb to the first wiring set (101Aa, 101Ba, 101Ca) of the second speaker 100B, a user may perform the operation with one hand, which may be advantageous in improving productivity. In addition, the user may wire the first and second cables Ca and Cb or other cable(s) to the second wiring set (101Ab, 101Bb, 101Cb) of the first speaker 100A (see FIG. 20) that corresponds to the second speaker 100B inverted 180 degrees. In other words, as the first wiring set (101Aa, 101Ba, 101Ca) of the second speaker 100B and the second wiring set (101Ab, 101Bb, 101Cb) of the first speaker 100A are disposed close to the rear surface of the speaker 100 and are spaced apart from the rear surface of the frame 60 (see FIG. 18) by a predetermined distance or more, the user may easily wire the cable(s) to the second speaker 100B and/or the first speaker 100A from the rear of the speaker 100 Meanwhile, the first inner support portion 101Ba or the first outer support portion 101Ca may be omitted from the first wiring set (101Aa, 101Ba, 101Ca). Meanwhile, the second inner support portion 101Bb or the second outer support portion 101Cb may be omitted from the second wiring set (101Ab, 101Bb, 101Cb).

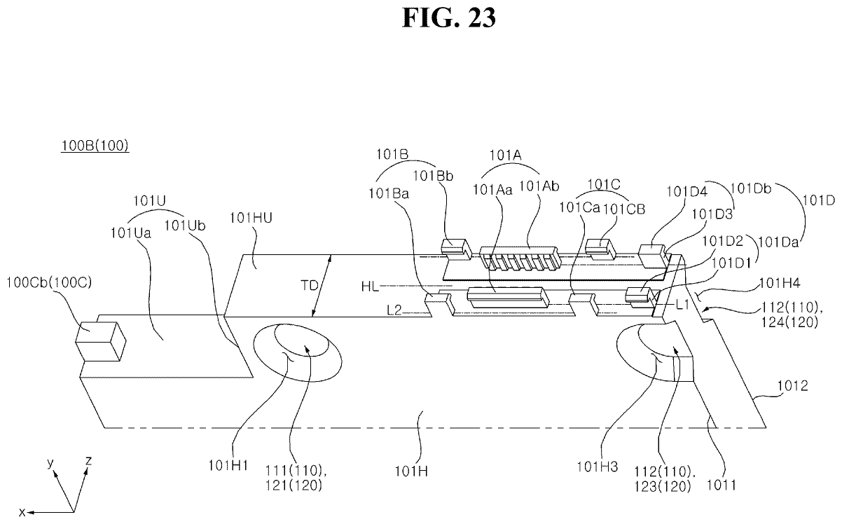

Referring to FIG. 23, the second speaker 100B may further include an auxiliary support portion 101D. The auxiliary support portion 101D and the fixing portion 101A may be spaced apart from each other with the outer support portion 101C interposed therebetween. Alternatively, the auxiliary support portion 101D and the fixing portion 101A may be spaced apart from each other with the inner support portion 101B interposed therebetween. A pair of auxiliary support portions 101Da and 101Db may be spaced apart from each other in the thickness direction TD of the speaker box 101H.

The first auxiliary support portion 101Da and the first fixing portion 101Aa may be located on a first line L1, and the first inner support portion 101Ba and the first outer support portion 101Ca may be located on a second line L2 that is different from the first line L1. The first line L1 and the second line L2 may be parallel to a horizontal line HL. The first auxiliary support portion 101Da may have a similar shape to the first fixing portion 101Aa. That is, the first auxiliary support portion 101Da may include an extension portion 101D1 that protrudes from the upper side 101HU and a protruding portion 101D2 that intersects the extension portion 101D1. The first auxiliary support portion 101Da may have a length less than the length of the first fixing portion 101Aa.

Accordingly, the first inner support portion 101Ba, the first fixing portion 101Aa, the first outer support portion 101Ca, and the first auxiliary support portion 101Da may be arranged in a zigzag manner.

The second auxiliary support portion 101Db and the second fixing portion 101Ab may be located on a third line, and the second inner support portion 101Bb and the second outer support portion 101Cb may be located on a fourth line that is different from the third line. The second auxiliary support portion 101Db may have a similar shape to the second fixing portion 101Ab. That is, the second auxiliary support portion 101Db may include an extension portion 101D3 that protrudes from the upper side 101HU and a protruding portion 101D4 that intersects the extension portion 101D3. The second auxiliary support portion 101Db may have a length less than the length of the second fixing portion 101Ab.

Accordingly, the second inner support portion 101Bb, the second fixing portion 101Ab, the second outer support portion 101Cb, and the second auxiliary support portion 101Db may be arranged in a zigzag manner.

A user may wire a cable(s) to the first wiring set (101Aa, 101Ba, 101Ca, 101Da) of the second speaker 100B or the second wiring set (101Ab, 101Bb, 101Cb, 101Db) of the first speaker 100A.

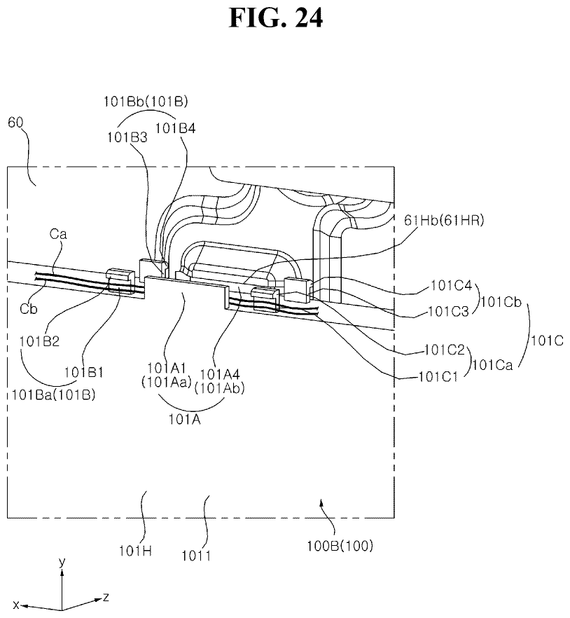

Referring to FIG. 24, a second pressed portion 61HR may be pressed rearward from the front surface of the frame 60. A second insertion hole 61Hb may be formed in the pressed portion 61HR. The second fixing portion 101Ab of the second speaker 100B may be inserted into the second insertion hole 61Hb and engaged (or retained) therein. The first fixing portion 101Aa of the first speaker 100A may be inserted into the first insertion hole 61Ha and engaged (or retained) therein (refer to FIG. 8 and FIG. 18). A first pressed portion 61HL may be pressed rearward from the front surface of the frame 60, and the first insertion hole 61Ha may be formed in the first pressed portion 61HL (see FIG. 8).

Accordingly, the second fixing portion 101Ab of the second speaker 100B and the first fixing portion 101Aa of the first speaker 100A may be used to couple the speaker 100 to the frame 60. In addition, the first fixing portion 101Aa of the second speaker 100B and second fixing portion 101Ab of the first speaker 100A may be used to couple the cables Ca and Cb to the speaker 100.

Meanwhile, the display device 1 described above and below may include only one speaker 100. In this case, one of the fixing portions 101Aa and 101Ab of the speaker 100 may be used to couple the speaker 100 to the frame 60, and the remaining one of the fixing portions 101Aa and 101Ab may be used to couple the cable to the speaker 100.

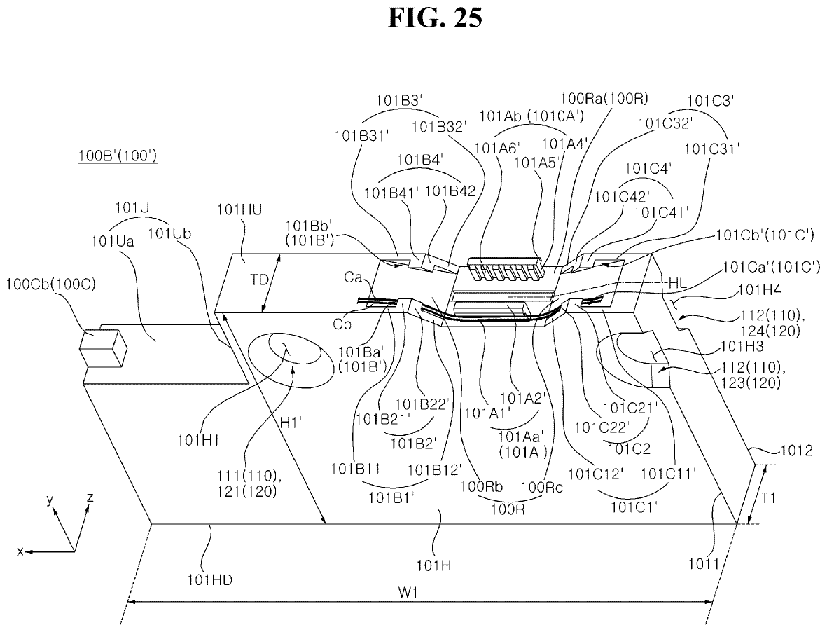

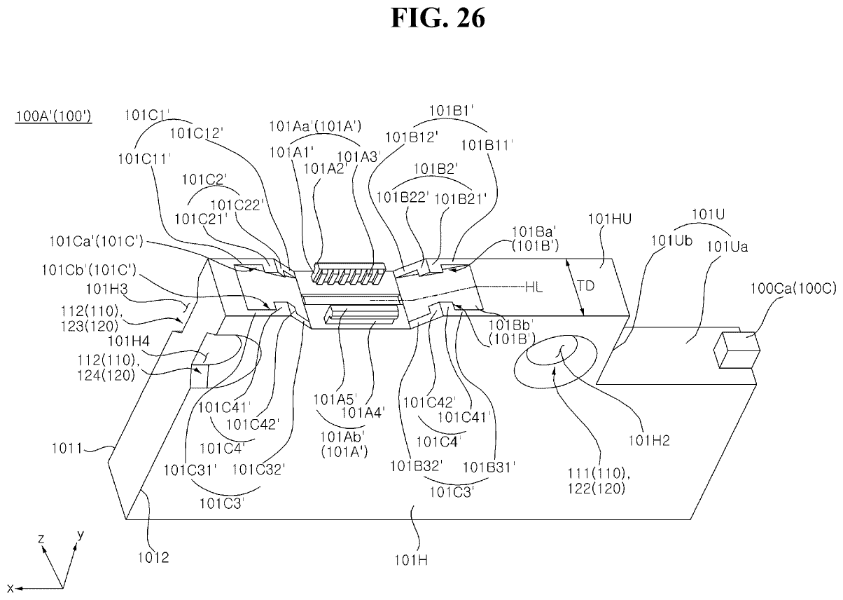

Referring to FIGS. 25 and 26, a second speaker 100B′ may include a recessed portion 100R. The recessed portion 100R may be recessed from one side of a speaker box 101H where a fixing portion 101A′ and a support portion 101B′, 101C′ are formed. The recessed portion 100R may be recessed from an upper side 101HU of the speaker box 101H. The recessed portion 100R may include a horizontal portion 100Ra, a first inclined portion 100Rb, and a second inclined portion 100Rc.

The horizontal portion 100Ra may be positioned lower than the upper side 101HU of the speaker box 101H. The horizontal portion 100Ra may be parallel to the upper side 101HU. The horizontal portion 100Ra may be flat. The horizontal portion 100Ra may be referred to as a horizontal surface 100Ra.

The first inclined portion 100Rb may connect one side (an inner side) of the horizontal portion 100Ra and the upper side 101HU, and may extend in an inclined manner. An angle between the first inclined portion 100Rb and the horizontal portion 100Ra may be an obtuse angle. The first inclined portion 100Rb may be referred to as an inner inclined portion 100Rb. The first inclined portion 100Rb may be referred to as a first inclined surface 100Rb.

The second inclined portion 100Rc may connect the other side (an outer side) of the horizontal portion 100Ra and the upper side 101HU, and may extend in an inclined manner. An angle between the second inclined portion 100Rc and the horizontal portion 100Rb may be an obtuse angle. The second inclined portion 100Rc may be referred to as an outer inclined portion 100Rc. The second inclined portion 100Rc may be referred to as a second inclined surface 100Rc.

The second speaker 100B′ may include a fixing portion 101A′ and a support portion 101B′, 101C′. The fixing portion 101A′ and the support portion 101B′, 101C′ may each have a hook shape. A horizontal line HL may extend horizontally (i.e., the left-right direction) while passing through the center of the recessed portion 100R.

The fixing portion 101A′ may protrude from the horizontal portion 100Ra of the second speaker 100B′. A pair of fixing portions 101Aa′ and 101Ab′ may be spaced apart from each other in a thickness direction TD of the speaker box 101H. The first fixing portion 101Aa′ may be adjacent to a rear end of the horizontal portion 100Ra, and the second fixing portion 101Ab′ may be adjacent to a front end of the horizontal portion 100Ra. The pair of fixing portions 101Aa′ and 101Ab′ may face each other in the thickness direction TD of the speaker box 101H. Alternatively, the pair of fixing portions 101Aa′ and 101Ab′ may be arranged in a staggered manner with respect to each other.

The first fixing portion 101Aa′ may include an extension portion 101A1′ and a protruding portion 101A2′. The extension portion 101A1′ may protrude upward form the horizontal portion 100Ra. The protruding portion 101A2′ may be adjacent to an end (i.e., an upper end) of the extension portion 101A1′, and may extend from the extension portion 101A1′ in a first direction intersecting the extension portion 101A1′. The protruding portion 101A2′ may be bent from the end of the extension portion 101A1′ in the first direction. For example, the first fixing portion 101Aa′ may be disposed closer to the horizontal line HL than first support portions 101Ba′ and 101Ca′, and the first direction may be a direction from the extension portion 101A1′ toward a space between the first support portions 101Ba′ and 101Ca′, namely, a direction from the second surface 1012 toward the first surface 1011. As another example, the first fixing portion 101Aa′ may be disposed farther from the horizontal lie HL than the first support portions 101Ba′ and 101Ca′, and the first direction may be a direction from the extension portion 101A1′ toward a space between the first support portions 101Ba′ and 101Ca′, namely, a direction from the first surface 1011 toward the second surface 1012. Ribs 101A3′ may protrude from one surface of the extension portion 101A1′ that is opposite to the protruding portion 101A2′. The ribs 101A3′ may be spaced apart from each other along the extension portion 101A1′.

The second fixing portion 101Ab′ may include an extension portion 101A4′ and a protruding portion 101A5′. The extension portion 101A4′ may protrude upward from the horizontal portion 100Ra. The protruding portion 101A5′ may be adjacent to an end (i.e., an upper end) of the extension portion 101A4′, and may extend from the extension portion 101A4′ in a third direction intersecting the extension portion 101A4′. The protruding portion 101A5′ may be bent from the end of the extension portion 101A4′ in the third direction. The third direction may be opposite to the first direction. Ribs 101A6′ may protrude from one surface of the extension portion 101A4′ that is opposite to the protruding portion 101A5′. The ribs 101A6′ may be spaced apart from each other along the extension portion 101A4′.

The support portion 101B′, 101C′ may protrude from the inclined portion 100Rb, 100Rc of the speaker box 101H. The support portion 101B′, 101C′ may include an inner support portion 101B′ and an outer support portion 101C′ that are spaced apart from each other with the fixing portion 101A′ interposed therebetween.

The inner support portion 101B′ may be formed on the first support portion 100Rb. The inner support portion 101B′ may be disposed closer to the center of the upper side 101H than the fixing portion 101A'. A pair of inner support portions 101Ba′ and 101Bb′ may be spaced apart from each other in the thickness direction TD of the speaker box 101H. The first inner support portion 101Ba′ may be adjacent to a rear end of the first inclined portion 100Rb, and the second inner support portion 101Bb′ may be adjacent to a front end of the first inclined portion 100Rb. The pair of inner support portions 101Ba′ and 101Bb′ may face each other in the thickness direction TD of the speaker box 101H. Alternatively, the pair of inner support portions 101Ba′ and 101Bb′ may be arranged in a staggered manner with respect to each other.

The first inner support portion 101Ba′ may include an extension portion 101B1′ and a protruding portion 101B2′. The extension portion 101B1′ may protrude upward from an upper surface of the first inclined portion 100Rb. The extension portion 101B1′ may be a triangular protruding portion that is adjacent to the rear end of the first inclined portion 100Rb. The extension portion 101B1′ may include a first side 101B11′ that is parallel to the upper side 101HU and a second side 101B12′ that forms an obtuse angle with the first side 101B11′. The protruding portion 101B2′ may be adjacent to a vertex of the extension portion 101B1′, namely, an intersection of the first side 101B11′ and the second side 101B12′, and may protrude from the extension portion 101B1′ in a second direction intersecting the extension portion 101B1′. The second direction may be opposite to the first direction. The protruding portion 101B2′ may be spaced apart from the first inclined portion 100Rb. The protruding portion 101B2′ may be a triangular protruding portion, and may include a first side 101B21′ that is parallel to the first side 101B11′ and a second side 101B22′ that is parallel to the second side 101B12′.

The second inner support portion 101Bb′ may include an extension portion 101B3′ and a protruding portion 101B4′. The extension portion 101B3′ may protrude upward from the upper surface of the first inclined portion 100Rb. The extension portion 101B3′ may be a triangular protruding portion that is adjacent to the front end of the first inclined portion 100Rb. The extension portion 101B3′ may include a first side 101B31′ that is parallel to the upper side 101HU and a second side 101B32′ that forms an obtuse angle with the first side 101B31′. The protruding portion 101B4′ may be adjacent to a vertex of the extension portion 101B3′, namely, an intersection of the first side 101B31′ and the second side 101B32′, and may protrude from the extension portion 101B3′ in a fourth direction intersecting the extension portion 101B3′. The fourth direction may be opposite to the third direction. The protruding portion 101B4′ may be spaced apart from the first inclined portion 100Rb. The protruding portion 101B4′ may be a triangular protruding portion, and may include a first side 101B41′ that is parallel to the first side 101B31′ and a second side 101B42′ that is parallel to the second side 101B32′.

The outer support portion 101C′ may be formed on the second inclined portion 100Rc. The outer support portion 101C′ may be disposed farther from the center of the upper side 101H than the fixing portion 101A′. A pair of outer support portions 101Ca′ and 101Cb′ may be spaced apart from each other in the thickness direction TD of the speaker box 101H. The first outer support portion 101Ca′ may be adjacent to a rear end of the second inclined portion 100Rc, and the second outer support portion 100Cb′ may be adjacent to a front end of the second inclined portion 100Rc. The pair of outer support portions 101Ca′ and 101Cb′ may face each other in the thickness direction TD of the speaker box 101H. Alternatively, the pair of outer support portions 101Ca′ and 101Cb′ may be arranged in a staggered manner with respect to each other.

The first outer support portion 101Ca′ may include an extension portion 101C1′ and a protruding portion 101C2′. The extension portion 101C1′ may protrude upward from an upper surface of the second inclined portion 100Rc. The extension portion 101C1′ may be a triangular protruding portion that is adjacent to the rear end of the second inclined portion 100Rc. The extension portion 101C1′ may include a first side 101C11′ that is parallel to the upper side 101HU and a second side 101C12′ that forms an obtuse angle with the first side 101C11′. The protruding portion 101C2′ may be adjacent to a vertex of the extension portion 101C1′, namely, an intersection of the first side 101C11′ and the second side 101C12′, and may protrude from the extension portion 101C1′ in the second direction intersecting the extension portion 101C1′. The second direction may be opposite to the first direction. The protruding portion 101C2′ may be spaced apart from the second inclined portion 100Rc. The protruding portion 101C2′ may be a triangular protruding portion, and may include a first side 101C21′ that is parallel to the first side 101C11′ and a second side 101C22′ that is parallel to the second side 101C12′.

The second outer support portion 101Cb′ may include an extension portion 101C3′ and a protruding portion 101C4′. The extension portion 101C3′ may protrude upward from the upper surface of the second inclined portion 100Rc. The extension portion 101C3′ may be a triangular protruding portion that is adjacent to the front end of the second inclined portion 100Rc. The extension portion 101C3′ may include a first side 101C31′ that is parallel to the upper side 101HU and a second side 101C32′ that forms an obtuse angle with the first side 101C31′. The protruding portion 101C4′ may be adjacent to a vertex of the extension portion 101C3′, namely, an intersection of the first side 101C31′ and the second side 101C32′, and may protrude from the extension portion 101C3′ in the fourth direction intersecting the extension portion 101C3′. The fourth direction may be opposite to the third direction. The protruding portion 101C4′ may be spaced apart from the second inclined portion 100Rc. The protruding portion 101C4′ may be a triangular protruding portion, and may include a first side 101C41′ that is parallel to the first side 101C31′ and a second side 101C42′ that is parallel to the second side 101C32′.

A first wiring set (101Aa′, 101Ba′, 101Ca′) may be disposed in a zigzag manner. The first wiring set (101Aa′, 101Ba′, 101Ca′) may be referred to as a first holding set (101Aa′, 101Ba′, 101Ca′).

A second wiring set (101Ab′, 101Bb′, 101Cb′) may be disposed in a zigzag manner. The second wiring set (101Ab′, 101Bb′, 101Cb′) may be referred to as a second holding set (101Ab′, 101Bb′, 101Cb′).

A first speaker 100A′ may correspond to the second speaker 100B′ inverted 180 degrees with respect to a vertical line VV′ (see FIG. 18) between the first and second speakers 100A′ and 100B′. The first fixing portion 101Aa′ of the first speaker 100A′ may be adjacent to a front end of the horizontal portion 100Ra, and the second fixing portion 101Ab′ thereof may be adjacent to a rear end of the horizontal portion 100Ra. The first inner support portion 101Ba′ of the first speaker 100A′ may be adjacent to a front end of the first inclined portion 100Rb, and the second inner support portion 101Bb′ thereof may be adjacent to a rear end of the first inclined portion 100Rb. The first outer support portion 101Ca′ of the first speaker 100A′ may be adjacent to a front end of the second inclined portion 100Rc, and the second outer support portion 101Cb′ thereof may be adjacent to a rear end of the second inclined portion 100Rc.

Accordingly, the second speaker 100B′ (see FIG. 25) may have the first wiring set (101Aa′, 101Ba′, 101Ca′) that is adjacent to a rear surface of the second speaker 100B′, namely, the first surface 1011. In addition, the first speaker 100A′ (see FIG. 26) may include the second wiring set (101Ab′, 101Bb′, 101Cb′) that is adjacent to a rear surface of the first speaker 100A′, namely, the second surface 1012.

A user may place first and second cables Ca and Cb between the first fixing portion 101Aa′ and the first support portions 101Ba′ and 101Ca′. The first and second cables Ca and Cb may be bent between the extension portions 101B1′, 101A1′, and 101C1′, and may be engaged with (or caught on) the extension portions 101B1′, 101A1′, and 101C1′. Portions of the bent first and second cables Ca and Cb may be under tension. In addition, the first and second cables Ca and Cb may be engaged with the protruding portions 101B2′, 101A2′, and 101C2′, thereby restricting upward movement.

In this manner, when wiring the first and second cables Ca and Cb to the first wiring set (101Aa′, 101Ba′, 101Ca′) of the second speaker 100B′, a user may perform the operation with one hand, which may be advantageous in improving productivity. In addition, the user may wire the first and second cables Ca and Cb or other cable(s) to the second wiring set (101Ab′, 101Bb′, 101Cb′) of the first speaker 100A′ (see FIG. 26) that corresponds to the second speaker 100B′ (see FIG. 25) inverted 180 degrees. In other words, as the first wiring set (101Aa′, 101Ba′, 101Ca′) of the second speaker 100B′ and the second wiring set (101Ab′, 101Bb′, 101Cb′) of the first speaker 100A′ are disposed close to the rear surface of a speaker 100′ and are spaced apart from the rear surface of the frame 60 (see FIG. 18) by a predetermined distance or more, the user may easily wire the cable(s) to the second speaker 100B′ and/or the first speaker 100A′ at the rear of the speaker 100′.

Meanwhile, the first inner support portion 101Ba′ or the first outer support portion 101Ca′ may be omitted from the first wiring set (101Aa′, 101Ba′, 101Ca′). Meanwhile, the second inner support portion 101Bb′ or the second outer support portion 101Cb′ may be omitted from the second wiring set (101Ab′, 101Bb′, 101Cb′).

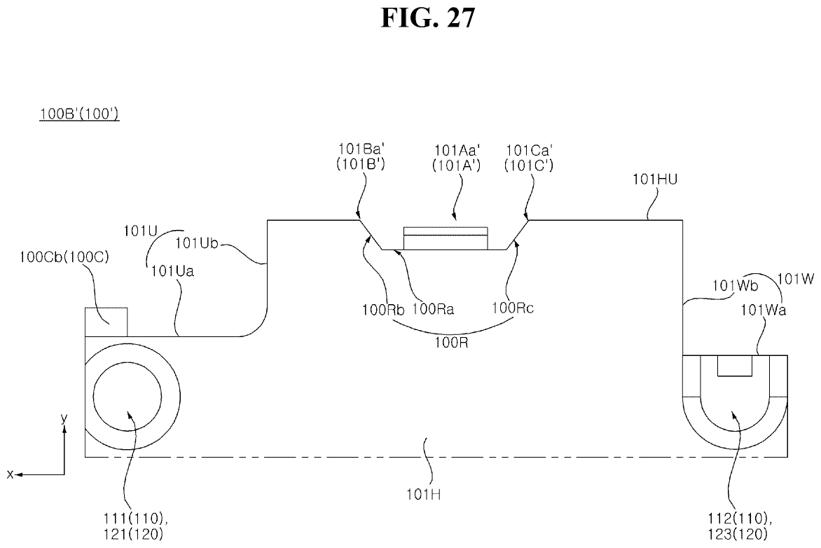

Referring to FIG. 27, a groove 101W may be formed from the upper side 101HU of the speaker box 101H to the inside of the speaker box 101H. The groove 101W may be opposite the groove 101U. The groove 101W may include a horizontal surface 101Wa and a vertical surface 101Wb. The cable connector 100C may be mounted on the horizontal surface 101Ua or the vertical surface 101U of the groove 101U. Alternatively, the cable connector 100C may be mounted on the horizontal surface 101Wa or the vertical surface 101Wb of the groove 101W. Alternatively, the cable connector 100C may be mounted on the upper side 101HU.

Referring back to FIG. 19, the speaker 100 including the fixing portion 101A and the support portions 101B and 101C may form an upper end of the speaker box 101H. For example, the support portions 101B and 101C may protrude further from the upper side 101HU than the fixing portion 101A, and may form the upper end of the speaker box 101H. In this case, a height H1 of the speaker box 101H may be a distance between a lower side 101HD of the speaker box 101H and the support portions 101B, 101C.

For example, the height of the support portions 101B, 101C with respect to the upper side 101HU may be 10 mm or less. For example, the height of the support portions 101B, 101C with respect to the upper side 101HU may be 7 mm. As the protruding heights of the fixing portion 101A and the support portions 101B and 101C decrease, interference between the speaker 100 and the surrounding component(s) may be easily avoided, allowing the speaker 100 to be commonly employed in display devices of various sizes or arrangements.

Referring back to FIG. 25, the fixing portion 101A′ and the support portions 101B′ and 101C′ of the speaker 100′ may be formed in the recessed portion 100R so as not to protrude from the upper side 101HU. The fixing portion 101A′ and the support portions 101B′ and 101C′ may be located at a level equal to or lower than the upper side 101HU. As the fixing portion 101A′ and the support portions 101B′ and 101C′ are disposed so as not to protrude from the upper side 101HU, interference between the speaker 100′ and the surrounding component(s) may be easily avoided, allowing the speaker 100′ to be commonly employed in display devices of various sizes or arrangements. The upper side 101HU of the speaker box 101H may form an upper end of the speaker box 101H. In this case, a height H1′ of the speaker box 101H may be a distance between a lower side 101HD and the upper side 101HU of the speaker box 101H.

The height H1′ of the speaker box 101H of the speaker 100′ (see FIG. 25) may be greater than the height H1 of the speaker box 101H of the speaker 100 (see FIG. 19). The speaker box 101H of the speaker 100′ may have a greater height (H1′) than the speaker box 101H of the speaker 100, and may have the recessed portion 100R where the fixing portion 101A′ and the support portions 101B′ and 101C′ are formed. A width W1 and a thickness T1 of the speaker box 101H of the speaker 100′ may be equal to a width W1 and a thickness T1 of the speaker box 101H of the speaker 100. The thickness T1 may be referred to as a depth T1. In response to the height difference between the speaker box 101H of the speaker 100′ and the speaker box 101H of the speaker 100, the speaker box 101H of the speaker 100′ may have a larger volume than the speaker box 101H of the speaker 100.

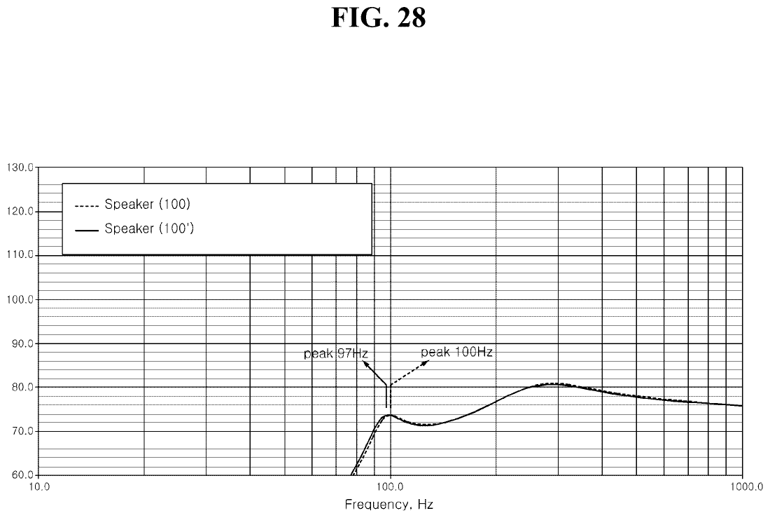

Referring to FIG. 28, based on the same speaker unit, the speaker 100 having the speaker box 101H with a relatively smaller volume may have a bass initial peak at a first frequency, and the speaker 100′ having the speaker box 101H with a relatively larger volume may have a bass initial peak at a second frequency lower (smaller) than the first frequency. For example, the first frequency may be 100 Hz, and the second frequency may be 97 Hz.

Accordingly, the bass reproduction range of the speaker 100′ (see FIG. 25 may be wider than the bass reproduction range of the speaker 100 (see FIG. 19).

Referring to FIG. 1 to 28, a display device 1 may include: a display panel 10; a frame 60 disposed at a rear of the display panel 10; a speaker (100; 100′) coupled to a rear of the frame 60; and a cable C disposed at the rear of the frame 60. The speaker (100; 100′) may include: a speaker box 101H; a first wiring set (101Aa, 101Ba, 101Ca; 101Aa′, 101Ba′, 101Ca′) protruding from one side of the speaker box 101H and disposed along the one side; and a second wiring set (101Ab, 101Bb, 101Cb; 101Ab′, 101Bb′, 101Cb′) protruding from the one side of the speaker box 101H, disposed along the one side, and spaced apart from the first wiring set (101Aa, 101Ba, 101Ca; 101Aa′, 101Ba′, 101Ca′) in a thickness direction TD of the speaker box 101H. The cable C may be engaged with any one of the first wiring set (101Aa, 101Ba, 101Ca; 101Aa′, 101Ba′, 101Ca′) and the second wiring set (101Ab, 101Bb, 101Cb; 101Ab′, 101Bb′, 101Cb′) that is positioned farther from a rear surface of the frame 60.

The speaker (100; 100′) may include: a first speaker (100A; 100A′); and a second speaker (100B; 100B′) spaced apart from the first speaker (100A; 100A′) and identical to the first speaker (100A; 100A′) inverted 180 degrees. The second wiring set (101Ab, 101Bb, 101Cb; 101Ab′, 101Bb′, 101Cb′) of the first speaker (100A; 100A′) may be farther from the rear surface of the frame 60 than the first wiring set (101Aa, 101Ba, 101Ca; 101Aa′, 101Ba′, 101Ca′) of the first speaker (100A; 100A′). The first wiring set (101Aa, 101Ba, 101Ca; 101Aa′, 101Ba′, 101Ca′) of the second speaker (100B; 100B′) may be farther from the rear surface of the frame 60 than the second wiring set (101Ab, 101Bb, 101Cb; 101Ab′, 101Bb′, 101Cb′) of the second speaker (100B; 100B′). The cable C may be engaged with the first wiring set (101Aa, 101Ba, 101Ca; 101Aa′, 101Ba′, 101Ca′) of the second speaker (100B; 100B′).

The cable C may include: a first cable Ca electrically connected to the first speaker (100A; 100A′); and a second cable Cb electrically connected to the second speaker (100B; 100B′).

The first wiring set (101Aa, 101Ba, 101Ca; 101Aa′, 101Ba′, 101Ca′) of the first speaker (100A; 100A′) and the second wiring set (101Ab, 101Bb, 101Cb; 101Ab′, 101Bb′, 101Cb′) of the second speaker (100B; 100B′) may respectively couple the first speaker (100A; 100A′) and the second speaker (100B; 100B′) to the frame 60.

The display device 1 may further include: a first holder (121; 123) positioned between the frame 60 and the first speaker (100A; 100A′), and coupled to the frame 60 and the first speaker (100A; 100A′); and a second holder (122; 124) positioned between the frame 60 and the second speaker (100B; 100B′), and coupled to the frame 60 and the second speaker (100B; 100B′).

The first wiring set (101Aa, 101Ba, 101Ca; 101Aa′, 101Ba′, 101Ca′) and the second wiring set (101Ab, 101Bb, 101Cb; 101Ab′, 101Bb′, 101Cb′) may be symmetrical with respect to a straight line that passes through a center of the one side of the speaker box 101H and is parallel to the one side.

A portion of the cable C may be bent by the first wiring set (101Aa, 101Ba, 101Ca; 101Aa′, 101Ba′, 101Ca′).

The first wiring set (101Aa, 101Ba, 101Ca; 101Aa′, 101Ba′, 101Ca′) may include: a first fixing portion (101Aa; 101Aa′) protruding from the one side of the speaker box 101H; and a first support portion (101Ba, 101Ca; 101Ba′; 101Ca′) protruding from the one side of the speaker box 101H and spaced apart from the first fixing portion (101Aa; 101Aa′) along the one side. The first support portion (101Ba, 101Ca; 101Ba′; 101Ca′) may be spaced apart from the first fixing portion (101Aa; 101Aa′) in the thickness direction TD of the speaker box 101H. The portion of the cable C may be bent between the first fixing portion (101Aa; 101Aa′) and the first support portion (101Ba, 101Ca; 101Ba′; 101Ca′).

The first fixing portion (101Aa; 101Aa′) and the first support portion (101Ba, 101Ca; 101Ba′; 101Ca′) may each have a hook shape to allow the cable C to be engaged therewith.

The first support portion (101Ba, 101Ca; 101Ba′; 101Ca′) may include: a first inner support portion (101Ba; 101Ba′) and a first outer support portion (101Ca; 101Ca′) that are spaced apart from each other with the first fixing portion (101Aa; 101Aa′) interposed therebetween. The first inner support portion (101Ba; 101Ba′), the first fixing portion (101Aa; 101Aa′), and the first outer support portion (101Ca; 101Ca′) may be arranged in a zigzag manner along the one side of the speaker box 101H.

The first wiring set (101Aa, 101Ba, 101Ca, 101Da) may further include: a first auxiliary support portion 101Da protruding from the one side of the speaker box 101H and spaced apart from the first fixing portion 101Aa along the one side. The first fixing portion 101Aa and the first auxiliary support portion 101Da may be located on a first line L1, and the first inner support portion 101Ba and the first outer support portion 101Ca may be located on a second line L2 that is different from the first line L1. The first inner support portion 101Ba, the first fixing portion 101Aa, the first outer support portion 101Ca, and the first auxiliary support portion 101Da may be arranged in a zigzag manner along the one side of the speaker box 101H.

The speaker box 101H may include a recessed portion 100R recessed from the one side of the speaker box 101H. The first wiring set (101Aa′, 101Ba′, 101Ca′) and the second wiring set (101Ab′, 101Bb′, 101Cb′) may be formed in the recessed portion 100R.

The first wiring set (101Aa′, 101Ba′, 101Ca′) and the second wiring set (101Ab′, 101Bb′, 101Cb′) may be positioned at a level equal to or lower than the one side of the speaker box 101H.

The recessed portion 100R may include: a horizontal portion 100Ra that forms a step descending from the one side of the speaker box 101H; a first inclined portion 100Rb that connects one side of the horizontal portion 100Ra and the one side of the speaker box 101H; and a second inclined portion 100Rc that connects another side of the horizontal portion 100Ra and the one side of the speaker box 101H. The first wiring set (101Aa′, 101Ba′, 101Ca′) may include: a first fixing portion 101Aa′ protruding from the horizontal portion 100Ra; a first inner support portion 101Ba′ protruding from the first inclined portion 100Rb; and a first outer support portion 101Ca′ protruding from the second inclined portion 100Rc.

The first inner support portion 101Ba′, the first fixing portion 101Aa′, and the first outer support portion 101Ca′ of the first wiring set (101Aa′, 101Ba′, 101Ca′) may be arranged in a zigzag manner. The cable C may be engaged with the first wiring set (101Aa′, 101Ba′, 101Ca′).

The display device according to the present disclosure has the following effects.

According to at least one of the embodiments of the present disclosure, it is possible to provide a structure for wiring a cable to a speaker.

According to at least one of the embodiments of the present disclosure, it is possible to provide a structure for coupling a speaker to a frame and a structure for coupling a cable to the speaker.

According to at least one of the embodiments of the present disclosure, it is possible to provide a structure in which a first speaker and a second speaker, which is an inverted version of the first speaker, are coupled to a frame.

According to at least one of the embodiments of the present disclosure, it is possible to provide a structure for wiring a cable to a first speaker and/or a second speaker.

According to at least one of the embodiments of the present disclosure, it is possible to provide a structure that can extend a bass reproduction range by increasing the volume of a speaker.

According to at least one of the embodiments of the present disclosure, it is possible to provide a speaker that is compatible with various types of display devices.

Certain embodiments or other embodiments of the invention described above are not mutually exclusive or distinct from each other. Any or all elements of the embodiments of the invention described above may be combined or combined with each other in configuration or function.

For example, a configuration “A” described in one embodiment of the invention and the drawings and a configuration “B” described in another embodiment of the invention and the drawings may be combined with each other. Namely, although the combination between the configurations is not directly described, the combination is possible except in the case where it is described that the combination is impossible.

The foregoing embodiments are merely examples and are not to be considered as limiting the present disclosure. The scope of the present disclosure should be determined by rational interpretation of the appended claims, and all modifications within the equivalents of the disclosure are intended to be included within the scope of the present disclosure.

What is claimed is:

1. A display device comprising:
a display panel;
a frame positioned behind the display panel;
a speaker coupled to a rear of the frame; and
a cable disposed at the rear of the frame,
wherein the speaker comprises:
a speaker box;
a first wiring set protruding from one side of the speaker box and disposed along the one side; and
a second wiring set protruding from the one side of the speaker box, disposed along the one side, and spaced apart from the first wiring set in a thickness direction of the speaker box, and
wherein the cable is engaged with any one of the first wiring set and the second wiring set that is positioned farther from a rear surface of the frame.

2. The display device of claim 1, wherein the speaker comprises:
a first speaker; and
a second speaker spaced apart from the first speaker and identical to the first speaker inverted 180 degrees,
wherein the second wiring set of the first speaker is farther from the rear surface of the frame than the first wiring set of the first speaker,
wherein the first wiring set of the second speaker is farther from the rear surface of the frame than the second wiring set of the second speaker, and
wherein the cable is engaged with the first wiring set of the second speaker.

3. The display device of claim 2, wherein the cable comprises:
a first cable electrically connected to the first speaker; and
a second cable electrically connected to the second speaker.

4. The display device of claim 2, wherein the first wiring set of the first speaker and the second wiring set of the second speaker couple the first speaker and the second speaker to the frame, respectively.

5. The display device of claim 2, further comprising:
a first holder positioned between the frame and the first speaker, and coupled to the frame and the first speaker; and
a second holder positioned between the frame and the second speaker, and coupled to the frame and the second speaker.

6. The display device of claim 1, wherein the first wiring set and the second wiring set are symmetrical with respect to a straight line which passes through a center of the one side of the speaker box and which is parallel to the one side.

7. The display device of claim 1, wherein a portion of the cable is bent by the first wiring set.

8. The display device of claim 7, wherein the first wiring set comprises:
a first fixing portion protruding from the one side of the speaker box; and
a first support portion protruding from the one side of the speaker box and spaced apart from the first fixing portion along the one side,
wherein the first support portion is spaced apart from the first fixing portion in the thickness direction of the speaker box, and
wherein the portion of the cable is bent between the first fixing portion and the first support portion.

9. The display device of claim 8, wherein each of the first fixing portion and the first support portion have a hook shape with which the cable is engaged.

10. The display device of claim 8, wherein the first support portion comprises a first inner support portion and a first outer support portion which are spaced apart from each other with respect to the first fixing portion, and
wherein the first inner support portion, the first fixing portion, and the first outer support portion are arranged in a zigzag manner along the one side of the speaker box.

11. The display device of claim 10, wherein the first wiring set further comprises a first auxiliary support portion protruding from the one side of the speaker box and spaced apart from the first fixing portion along the one side,
wherein the first fixing portion and the first auxiliary support portion are positioned on a first line,
wherein the first inner support portion and the first outer support portion are positioned on a second line which is different from the first line, and
wherein the first inner support portion, the first fixing portion, the first outer support portion, and the first auxiliary support portion are arranged in a zigzag manner along the one side of the speaker box.

12. The display device of claim 1, wherein the speaker box comprises a recessed portion recessed from the one side of the speaker box, and
wherein the first wiring set and the second wiring set are formed at the recessed portion.

13. The display device of claim 12, wherein the first wiring set and the second wiring set are positioned at a level equal to or lower than the one side of the speaker box.

14. The display device of claim 12, wherein the recessed portion comprises:
a horizontal portion stepped down from the one side of the speaker box;
a first inclined portion connecting one side of the horizontal portion and the one side of the speaker box; and
a second inclined portion connecting another side of the horizontal portion and the one side of the speaker box, and
wherein the first wiring set comprises:
a first fixing portion protruding from the horizontal portion;
a first inner support portion protruding from the first inclined portion; and
a first outer support portion protruding from the second inclined portion.

15. The display device of claim 14, wherein the first inner support portion, the first fixing portion, and the first outer support portion of the first wiring set are arranged in a zigzag manner, and
wherein the cable is engaged with the first wiring set.
